(19) United States
(12) Patent Application Publication
(10) Pub. No.: US 2014/0333945 A1
(43) Pub. Date: Nov. 13, 2014

(54) PRINTING APPARATUS, METHOD FOR CONTROLLING PRINTING APPARATUS, AND STORAGE MEDIUM

(71) Applicant: CANON KABUSHIKI KAISHA, Tokyo (JP)

(72) Inventor: Munetaka Sakata, Kawasaki-shi (JP)

(73) Assignee: CANON KABUSHIKI KAISHA, Tokyo (JP)

(21) Appl. No.: 14/272,383

(22) Filed: May 7, 2014

(30) Foreign Application Priority Data
May 10, 2013 (JP) 2013-099918

(51) Int. Cl. H04N 1/00

(52) U.S. Cl. CPC H04N 1/00631; H04N 1/00591
USPC 358/1.12

(57) ABSTRACT

A control method for controlling a printing apparatus and allowing a user to easily examine a variation of a printed image occurring before and after print interruption is provided. The control method includes printing an image on a sheet, discharging the sheet having the image printed thereon by the printing unit onto a first stacking unit, interrupting, upon receiving an instruction from a user, a print operation performed by the printing unit, and performing, upon receiving an instruction from the user, control so that a sheet having a predetermined image printed thereon by the printing unit is discharged onto a second stacking unit before the print operation performed by the printing unit is interrupted, and a sheet having the predetermined image printed thereon by the printing unit is discharged onto the second stacking unit after the print operation performed by the printing unit is started.

### BACKGROUND OF THE INVENTION

1. Field of the Invention

The present invention relates to a printing apparatus, a method for controlling a printing apparatus, and a storage medium.

2. Description of the Related Art

In recent years, production printing market has been expanded. Thus, a large amount of print materials are frequently produced using a printing apparatus, such as a digital copier or a digital multifunction peripheral (MFP).

In printing using a digital copier or a digital multifunction peripheral, a print engine automatically performs the following processes in order to improve the print quality of print materials. That is, for example, the print engine automatically controls a fixing temperature to an appropriate temperature when toner is fixed to printing paper (hereinafter referred to as a “medium”). In addition, if the interval of print jobs becomes too long or if a print job is suspended, the print engine automatically performs a cleaning operation, such as wiping of residual toner.

Although the above-described processes are necessary to improve the print quality of a print material, the print conditions may vary after the automatic temperature control or the cleaning operation is performed by the print engine and, thus, a slight variation of tint may occur. To detect the occurrence of a variation of tint, the variation of tint of a print material can be examined directly by the eye (refer to, for example, Japanese Patent Laid-Open No. 2009-216780). In addition, a technique for determining whether sample print is available has been developed (refer to, for example, Japanese Patent Laid-Open No. 2009-200547).

For example, Japanese Patent Laid-Open No. 2009-216780 describes a technique in which an event that requires a sample print is defined and a sample print is automatically produced if printing of a print job that is effected by the event for a sample print occurs for the first time. For example, if cyan toner is refilled, a sample print is produced when a first color print job is run after the cyan toner is refilled.

Japanese Patent Laid-Open No. 2009-200547 describes a technique in which the execution authority of sample print is managed and it is determined whether a sample print is required on the basis of the privilege of an operator. Since it is determined whether a sample print is required on the basis of the privilege of an operator by using such a technique, leakage of secret information caused by a sample print can be prevented.

However, the technique described in Japanese Patent Laid-Open No. 2009-216780 is not suitable for detecting whether a variation of the tint occurs during a print operation performed by a print job that generates a large amount of print materials, since a sample print is produced when printing starts.

In addition, in general, when a large amount of print material are generated, an operator removes the print material stacked in a high-capacity stacker and puts the print material on a carrier to move the print material for post-processing, such as finishing processing. When the operator removes the print material from the high-capacity stacker, printing is temporarily stopped. Accordingly, a slight tint variation may occur after the print material is removed.

In such an operation scheme, the operator determines whether a tint variation occurs before moving the print material for post-processing. If a tint variation occurs, the operator needs to stop the current print job to prevent generation of a large amount of the print material having uneven image quality.

In addition, although a technique described in Japanese Patent Laid-Open No. 2009-200547 can automatically determine whether a sample print is available on the basis of the privilege of an operator, the technique for the determination does not take into account the operator's intension.

More specifically, when the operator removes the print material stacked in the high-capacity stacker in order to move the print material for the post-processing (e.g., finishing processing), the operator needs to examine a tint variation by producing a sample print. However, if the operator stops the printing apparatus in an emergency and removes the stack of a print material from the high-capacity stacker, a sample print is not needed.

### SUMMARY OF THE INVENTION

According to an embodiment of the present invention, a printing apparatus includes

a printing unit configured to print an image on a sheet, a discharging unit configured to discharge the sheet having the image printed thereon by the printing unit onto a first stacking unit, an interrupting unit configured to, upon receiving an instruction from a user, interrupt a print operation performed by the printing unit, and a control unit configured to, upon receiving an instruction from the user, perform control so that a sheet having a predetermined image printed thereon by the printing unit is discharged onto a second stacking unit before the print operation performed by the printing unit is interrupted, and a sheet having the predetermined image printed thereon by the printing unit is discharged onto the second stacking unit after the print operation performed by the printing unit is started.

Further features of the present invention will become apparent from the following description of exemplary embodiments with reference to the attached drawings.

### BRIEF DESCRIPTION OF THE DRAWINGS

FIG. 1 illustrates the configuration of a printing system including a printing apparatus.

FIG. 2 illustrates the configuration of the printing apparatus illustrated in FIG. 1.

FIG. 3 is a cross-sectional view of an external paper feed unit and another external paper feed unit illustrated in FIG. 2.

FIG. 4 is a cross-sectional view illustrating the configuration of the body of an image forming unit illustrated in FIG. 2.

FIGS. 5A and 5B illustrate the configuration of a high-capacity stacker illustrated in FIG. 2.

FIG. 6 is a block diagram of the hardware configuration of the printing apparatus illustrated in FIG. 1.

FIG. 7 is a block diagram of the detailed configuration of a stacker control unit illustrated in FIG. 6.

FIG. 8 is a block diagram of the hardware configurations of an information processing apparatus illustrated in FIG. 1.

FIG. 9 is a block diagram of the software configurations of the printing system illustrated in FIG. 1.

FIG. 10 illustrates an example of a UI screen displayed on a display unit of the information processing apparatus.

FIG. 11 illustrates an example of a UI screen displayed on the display unit of the information processing apparatus.

FIG. 12 illustrates an example of a UI screen displayed on the display unit of the information processing apparatus.

FIG. 13 is a flowchart illustrating a technique for controlling the image information apparatus.

FIG. 14 is a flowchart illustrating a technique for controlling the printing apparatus.

FIGS. 15A and 15B illustrates examples of a UI screen displayed on the display unit of the information processing apparatus.

FIG. 16 is a flowchart illustrating a technique for controlling an image information apparatus.

FIG. 17 is a flowchart illustrating a technique for controlling the printing apparatus.

FIG. 18 illustrates an example of a UI screen displayed on the display unit of the information processing apparatus.

FIG. 19 is a flowchart illustrating a technique for controlling a printing apparatus.

FIG. 20 is a flowchart illustrating a technique for controlling a printing apparatus.

FIGS. 21A and 21B illustrate examples of a UI screen displayed on the display unit of the information processing apparatus.

FIG. 22 is a flowchart illustrating a technique for controlling the printing apparatus.

FIG. 23 is a flowchart illustrating a technique for controlling the printing apparatus.

FIG. 24 is a flowchart illustrating a technique for controlling the printing apparatus.

FIG. 25 illustrates an example of a UI screen displayed on the display unit of the information processing apparatus.

FIG. 26 is a flowchart illustrating a technique for controlling the printing apparatus.

### DESCRIPTION OF THE EMBODIMENTS

Exemplary embodiments of the present invention are described below with reference to the accompanying drawings. System Configuration

### First Exemplary Embodiment

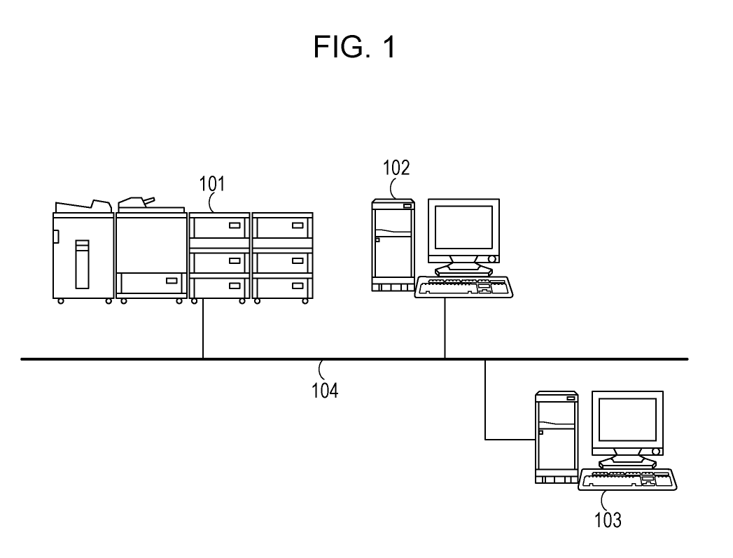

FIG. 1 illustrates the configuration of a printing system including a printing apparatus according to a first exemplary embodiment. Note that the present exemplary embodiment is described with reference to a multi function peripheral (MFP) that performs multiple functions as an example of the printing apparatus. The printing system includes a printing apparatus 101, an information processing apparatus 102, an information processing apparatus 103, and a network 104.

As illustrated in FIG. 1, the information processing apparatus 103 functions as a client. Upon receiving a request from an operator, the information processing apparatus 103 performs a process, such as print job setting, and sends a print job to the information processing apparatus 102. The information processing apparatus 102 functions as a server. The information processing apparatus 102 receives a print job and performs a process, such as job management, raster image processing (RIP), and page layout. Thereafter, the information processing apparatus 102 makes prints using the printing apparatus 101. The printing apparatus 101, the information processing apparatus 102, and the information processing apparatus 103 are connected with one another via the network 104.

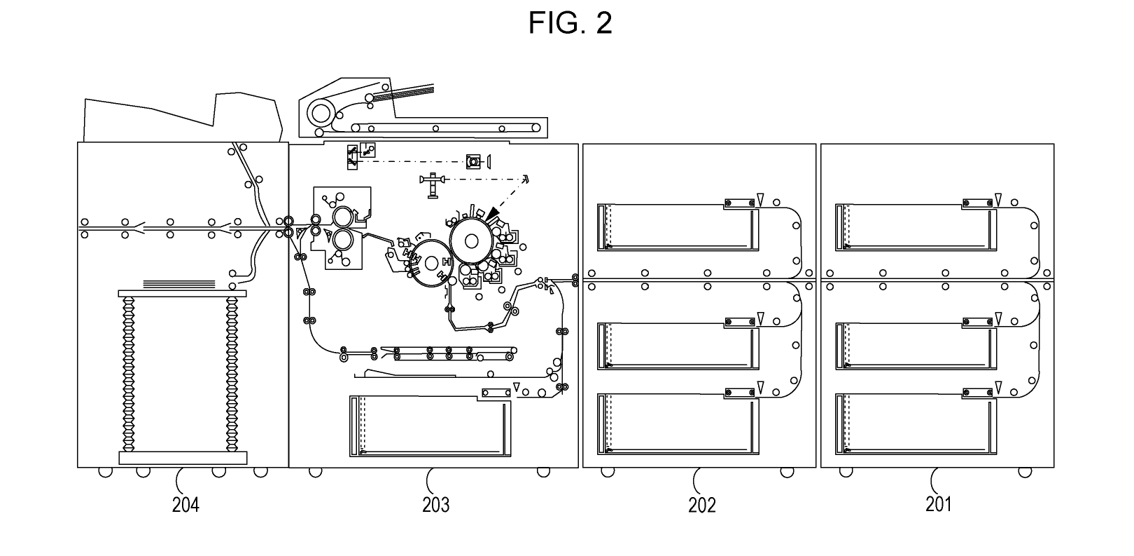

FIG. 2 illustrates the configuration of the printing apparatus 101 illustrated in FIG. 1.

As illustrated in FIG. 2, the printing apparatus 101 includes an external paper feed unit 201, an external paper feed unit 202, an image forming unit 203, and a high-capacity stacker 204.

The external paper feed unit 201 and the external paper feed unit 202 are provided to supply a large amount of print sheets (hereinafter simply referred to as “sheets”) to the image forming unit 203. The image forming unit 203 carries out printing on a sheet fed from the external paper feed unit 201, the external paper feed unit 202, or a paper feed tray attached to the image forming unit 203. The high-capacity stacker 204 serves as a delivery unit that can store a large amount of printed material. In general, the high-capacity stacker 204 is used to hold a large amount of printed materials when the external paper feed unit 201 and the external paper feed unit 202 are used. Note that a case book binding apparatus or a saddle stitching apparatus (neither is illustrated) may be connected downstream of the high-capacity stacker 204.

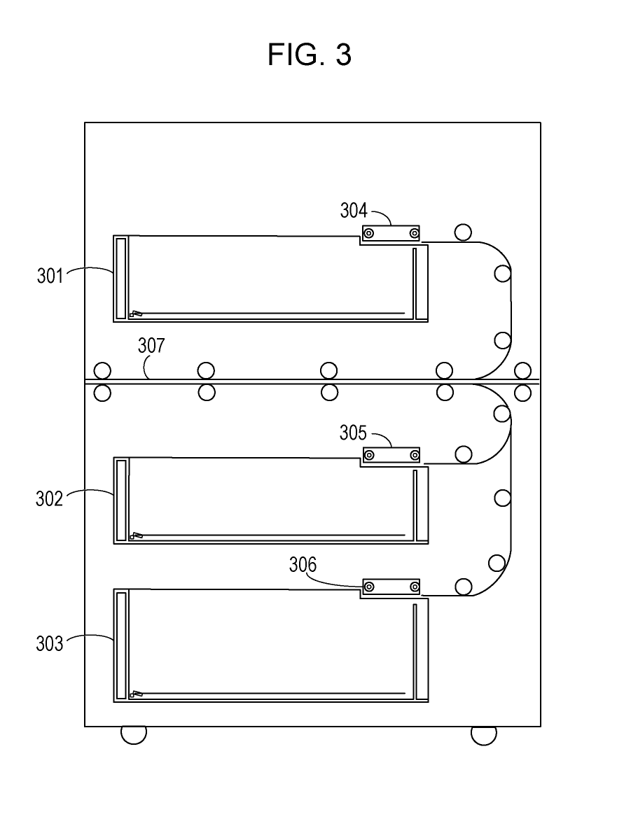

FIG. 3 is a cross-sectional view of the external paper feed unit 201 and the external paper feed unit 202 illustrated in FIG. 2.

As illustrated in FIG. 3, a straight path 307 is a path along which a medium (also referred to as a “sheet”) conveyed from a paper feed tray 301, a paper feed tray 302, a paper feed tray 303 and a medium conveyed from the upstream side are further conveyed to the downstream side.

According to the present exemplary embodiment, the external paper feed unit 201 is disposed upstream of the external paper feed unit 202, and the image forming unit 203 is disposed downstream of the external paper feed unit 202. Accordingly, the external paper feed unit 202 conveys, to the image forming unit 203, a medium stored in the paper feed tray 301, the paper feed tray 302, or the paper feed tray 303 or a medium conveyed from the external paper feed unit 201 via the straight path 307.

The paper feed tray 301, the paper feed tray 302, and the paper feed tray 303 can allow fed media to be brought into contact with a feed motor 304, a feed motor 305, and a feed motor 306, respectively, by lifting up the bottom portion of each of the paper feed trays using a lift up motor (not illustrated). Such a mechanism allows media to be fed regardless of the amount of media.

The feed motor 304, the feed motor 305, and the feed motor 306 pick up media stored in the paper feed tray 301, the paper feed tray 302, and the paper feed tray 303, respectively, one by one. The media stored in the paper feed tray 301, the paper feed tray 302, and the paper feed tray 303 are moved to a conveying path by the feed motor 304, the feed motor 305, and the feed motor 306, respectively, so as to be conveyed to the straight path 307.

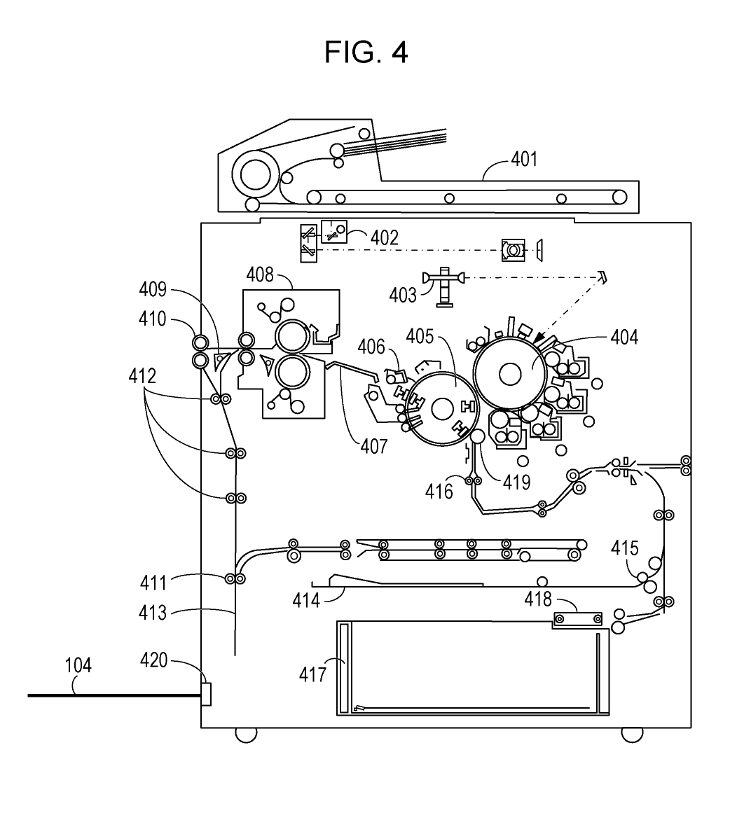

FIG. 4 is a cross-sectional view illustrating the configuration of the image forming unit 203 illustrated in FIG. 2.

As illustrated in FIG. 4, an automatic document feeder (ADF) 401 sequentially separates a stack of document sheets placed on a loading surface of a document tray from a first page and conveys the sheet onto platen glass so that a scanner 402 can scan the image on the document sheet. The scanner 402 scans the image of the document conveyed to the platen grass and converts the image into image data by using a charge coupled device (CCD).

A rotary multifaceted mirror 403 (e.g., a polygon mirror) receives a light ray (e.g., a laser beam) modulated in accordance with the image data and emits the light ray onto a photoconductive drum 404 via a reflecting mirror in the form of reflection scan light. A latent image formed on the photoconductive drum 404 by the laser beam is developed with toner. The toner image is transferred onto a medium stuck to a transfer drum 405. Such a series of image forming processes is sequentially performed for yellow (Y) toner, magenta (M) toner, cyan (C) toner, and black (K) toner so that a full-color image is generated. After the four image forming processes are performed, the medium having the full-color image transferred thereonto is separated from the transfer drum 405 by a separation pawl 406 and is conveyed to a fixing unit 408 by a pre-fixing conveyor 407.

The fixing unit 408 is configured by combining rollers and belts. The fixing unit 408 includes a heat source, such as a halogen heater, which melts toner of the toner image transferred onto the medium by heat and fixes the toner image onto the medium by applying pressure. A discharge flapper 409 is swingable about a swing axis so as to regulate a direction in which the medium is conveyed. If the discharge flapper 409 swings in the clockwise direction in FIG. 4, the medium is conveyed straight forward and is output to the outside of the apparatus by a discharge roller 410.

In contrast, if images are formed on both sides of the medium, the discharge flapper 409 swings in the counterclockwise direction in FIG. 4. Thus, the direction in which the medium is conveyed is changed to the downward direction and is delivered into a two-sided conveyance unit. The two-sided conveyance unit includes an inversion flapper 411, an inversion roller 412, an inversion guide 413, and a duplex tray 414. The inversion flapper 411 is swingable about a swing axis and regulates a direction in which the medium is conveyed.

When a duplex print job is processed, the inversion flapper 411 swings in the counterclockwise direction in FIG. 4 so that a sheet having a first printed surface is delivered into the inversion guide 413 via the inversion roller 412. Thereafter, the inversion roller 412 is temporarily stopped with the trailing edge of the medium pinched by the inversion roller 412. Subsequently, the inversion flapper 411 swings in the clockwise direction in FIG. 4. In addition, the inversion roller 412 is continuously rotated in the opposite direction. In this manner, the sheet switchbacks and is conveyed. Thus, the sheet is delivered onto the duplex tray 414 with the leading and trailing edges reversed.

The medium is temporarily placed on the duplex tray 414 and, subsequently, is delivered into a registration roller 416 again by a re-feed roller 415. At that time, the medium is delivered with a surface opposite to the first transferred surface facing the photoconductive drum 404. Subsequently, an image to be printed on the second surface is formed on the second surface of the sheet in the same manner as described above.

Thus, the images are formed on both sides of the medium and are fixed in a fixing process. Thereafter, the medium is output from the body of the printing apparatus to the outside via the discharge roller 410. By performing the above-described duplex printing sequence, duplex printing in which images are printed on the first and second surfaces of a sheet of the duplex print job can be performed by the printing apparatus.

A paper feed tray 417 is used to feed media. By lifting up the bottom portion of the paper feed tray 417 using a lift up motor (not illustrated), a medium to be fed can be brought into contact with a feed motor 418. Such a mechanism allows the media to be fed regardless of the amount of the media.

The feed motor 418 picks up the media stored in the paper feed tray 417 one by one. Each of the media stored in the paper feed tray 417 is delivered into the conveying path by the feed motor 418.

The medium delivered from the paper feed tray 417 is led between conveyance guides and is conveyed to the registration roller 416 by a plurality of conveying rollers. At that time, the registration roller 416 is stopped. The leading edge of the medium hits a nip portion formed by a pair of the registration rollers 416 so that the medium has a curved shape. In this manner, skew of the medium is corrected.

Thereafter, the rotation of the registration roller 416 is started to convey the medium in synchronization with formation of a toner image on the photoconductive drum 404 in an image forming section. The medium delivered by the registration roller 416 is electrostatically sucked onto the surface of the transfer drum 405 by an attracting roller 419. The medium output from the fixing unit 408 is output to the outside of the apparatus via the discharge roller 410. A network connector 420 serves as a connection unit with the network 104. For example, the network 104 is Ethernet®, the network connector 420 has an RJ-45 type plug. Note that while the present exemplary embodiment is described with reference to an image forming apparatus having a single photoconductor drum, the image forming apparatus may have four photoconductor drums.

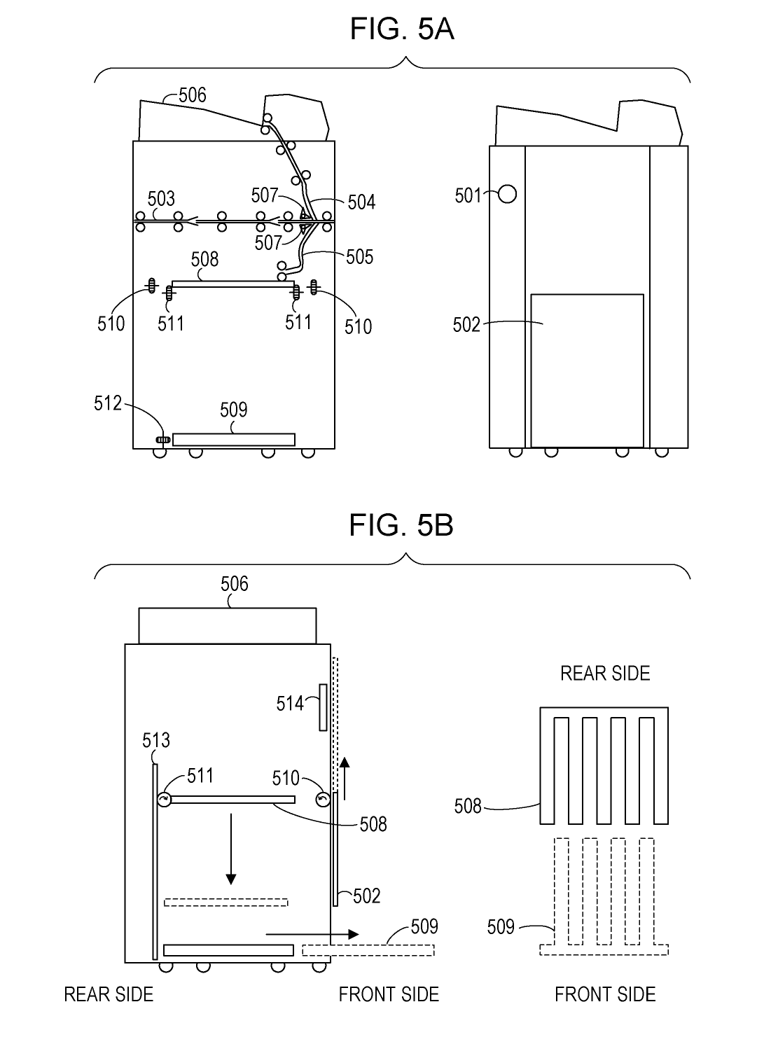

FIGS. 5A and 5B illustrate the configuration of the high-capacity stacker 204 illustrated in FIG. 2. More specifically, FIG. 5A is an external view and a cross-sectional view of the high-capacity stacker 204. In addition, FIG. 5B is a side view and a top view of the high-capacity stacker 204.

In the external view of FIG. 5A, a button 501 serves as a stack eject button, which is pressed in order to remove, from the high-capacity stacker 204, printed media stacked on a lift table 508 of the high-capacity stacker 204. A slide door 502 serves as a front cover of the high-capacity stacker 204. At normal times, the slide door 502 is closed down. When the printed material is removed from the high-capacity stacker 204, the slide door 502 is slid upward.

As illustrated in the front view of FIG. 5A and the side view of FIG. 5B, the high-capacity stacker 204 includes the following three conveying paths: a straight path 503, an escape path 504, and a stack path 505. In addition, the high-capacity stacker 204 includes an escape tray 506 and a lift table 508. The straight path 503 is used as a sheet conveying path for conveying a medium received from the image forming unit 203.

A pair of sheet discharge flappers 507 is configured to be swingable about a swing axis and regulates a direction in which the medium is conveyed. If the upper sheet discharge flapper 507 swings in the counterclockwise direction in FIG. 5A, the medium is conveyed to the escape path 504. However, if the lower sheet discharge flapper 507 swings in the clockwise direction in FIG. 5A, the medium is conveyed to the stack path 505. Furthermore, if neither upper nor lower sheet discharge flapper 507 swings, the medium is conveyed to the straight path 503.

The escape path 504 is used to output a medium without stacking the medium on the lift table 508. For example, when a sample print is produced, a medium is output from the escape path 504 to the escape tray 506.

The stack path 505 is used to convey a medium onto the lift table 508. For example, if an operator submits a job that outputs a printed material into a stacking unit of the high-capacity stacker 204, a medium is output onto the lift table 508 via the stack path 505.

The lift table 508 is a table on which a medium is stacked. An eject table 509 is a table used to move a medium from the inside to the outside of the high-capacity stacker 204.

A motor 510 is used to move the slide door 502 upward or downward. A gear (not illustrated) that receives rotation of the motor 510 is in contact with the slide door 502. Accordingly, by controlling the rotation of the motor 510 in the clockwise direction or counterclockwise direction, the slide door 502 can be moved upward or downward.

A motor 511 is used to move the lift table 508 upward or downward. The motor 511 is connected to the lift table 508. In addition, a gear (not illustrated) that receives rotation of the motor 511 is in contact with a guide rail 513.

The guide rail 513 is used when the lift table 508 is moved upward or downward. The guide rail 513 is disposed so as to extend in the vertical direction. Accordingly, by controlling the rotation of the motor 511 in the clockwise direction or counterclockwise direction, the lift table 508 can be moved upward or downward. In addition, the lift table 508 can be lowered to the height of the eject table 509.

Note that a motor 512 is used to move the eject table 509 from the inside to outside of the high-capacity stacker 204. A gear (not illustrated) that receives the rotation of the motor 512 is in contact with the eject table 509. Accordingly, by controlling the rotation of the motor 512 in the clockwise direction or counterclockwise direction, the eject table 509 can be moved forward or rearward. A button press detecting unit 514 is in the form of a circuit board that detects the pressing of the button 501.

In the top view of FIG. 5B, the shapes of the lift table 508 and the eject table 509 are illustrated. The shapes of the lift table 508 and the eject table 509 are determined so that convex portions of the lift table 508 are not in contact with concave portions of the eject table 509 and, similarly, convex portions of the eject table 509 are not in contact with concave portions of the lift table 508. Accordingly, the lift table 508 can be lowered to the height of the eject table 509 or lower.

Thus, to output the media placed on the lift table 508 to the outside, the high-capacity stacker 204 performs the following operation.

By controlling the rotation of the motor 510, the slide door 502 is moved upward first. Subsequently, by controlling the motor 511, the lift table 508 is lowered to the height of the eject table 509 or lower. As a result, due to the shapes of the lift table 508 and the eject table 509, the media placed on the lift table 508 is loaded on the eject table 509. Thereafter, by controlling the motor 512, the eject table 509 is moved forward. In this manner, the media stacked on the lift table 508 are output to the outside of the high-capacity stacker 204. When the eject table 509 is moved forward, the eject table 509 can be lift up and, thus, allows subsequently output printed materials to be loaded thereon.

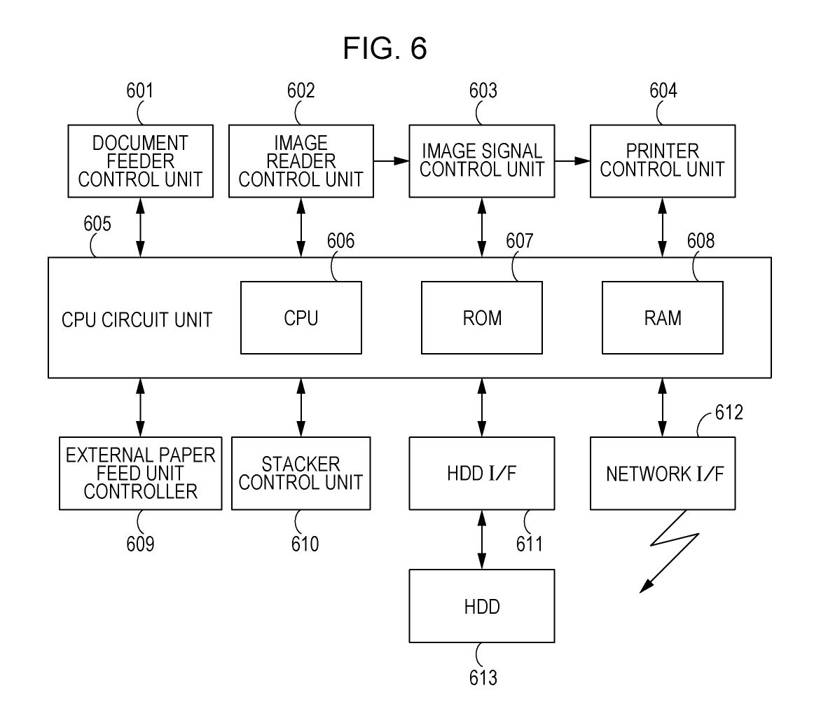

FIG. 6 is a block diagram of the hardware configuration of the printing apparatus 101 illustrated in FIG. 1.

As illustrated in FIG. 6, a CPU circuit unit 605 includes a central processing unit (CPU) 606. The CPU circuit unit 605 controls a control unit (described below) in accordance with a program stored in a read only memory (ROM) 607. The control unit includes a document feeder control unit 601, an image reader control unit 602, an image signal control unit 603, a printer control unit 604, an external paper feed unit controller 609, a stacker control unit 610, an HDD interface (I/F) 611, and a network interface 612. The document feeder control unit 601 controls the automatic document feeder 401. The image reader control unit 602 controls the scanner 402.

The printer control unit 604 controls, for example, the photoconductive drum 404, the fixing unit 408, and the paper feed tray 417. The external paper feed unit controller 609 controls the external paper feed unit 201 and the external paper feed unit 202. The stacker control unit 610 controls the high-capacity stacker 204.

The HDD I/F 611 serves as an interface with a hard disk drive (HDD) 613. The HDD I/F 611 controls read and write operations on the HDD 613. The network interface 612 controls communication of data via the network 104. The HDD 613 is a nonvolatile large-capacity storage unit for storing data.

A random access memory (RAM) 608 is used as an area for temporarily holding control data and a work area for computation required for control. The network interface 612 is connected to, for example, the information processing apparatus 102 via the network 104.

Note that an image scanned by the scanner 402 is output from the image reader control unit 602 to the image signal control unit 603. Thereafter, the image output from the image signal control unit 603 to the printer control unit 604 is subjected to image formation and is printed on a medium supplied from, for example, the paper feed tray 417. Subsequently, the printed medium is subjected to post-processing in accordance with the output format specified by the user. As used herein, the term “post-processing” refers to the processing performed by the stacker control unit 610. For example, if the medium is output into the high-capacity stacker 204, the stacker control unit 610 performs control so that the medium is output onto the escape tray 506 or the lift table 508 in accordance with the destination of a printout.

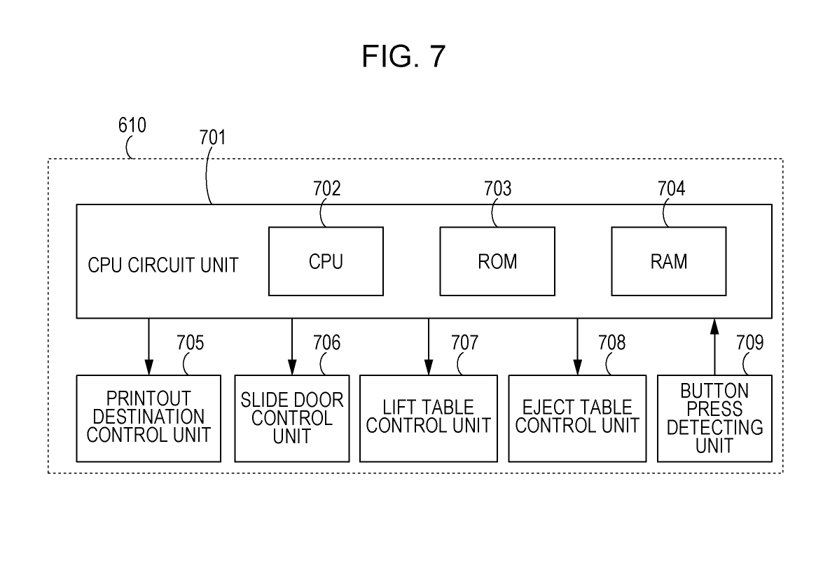

FIG. 7 is a block diagram of the detailed configuration of the stacker control unit 610 illustrated in FIG. 6.

As illustrated in FIG. 7, a CPU circuit unit 701 includes a CPU 702. The CPU circuit unit 701 controls a control unit described below in accordance with a program stored in a ROM 703. The control unit includes a printout destination control unit 705, a slide door control unit 706, a lift table control unit 707, an eject table control unit 708, and a button press detection unit 709.

The printout destination control unit 705 controls the pair of sheet discharge flappers 507 to select a printout destination. The slide door control unit 706 controls the motor 510 so as to control the upward or downward movement of the slide door 502. The lift table control unit 707 controls the motor 511 so as to control the upward or downward movement of the lift table 508. The eject table control unit 708 controls the motor 512 so as to control the forward or rearward movement of the eject table. The button press detection unit 709 controls the button press detecting unit 514 so as to detect whether the button 501 is pressed. Note that a RAM 704 serves as a work area of the CPU 702.

The CPU circuit unit 701 serves as an interface circuit between the CPU circuit unit 605 and each of the printout destination control unit 705, the slide door control unit 706, the lift table control unit 707, the eject table control unit 708, and the button press detection unit 709. The CPU circuit unit 701 mediates an instruction from the CPU circuit unit 605 and a message from the control unit.

For example, to switch the destination of the medium to the escape tray 506, the CPU circuit unit 605 instructs the CPU circuit unit 701 to switch the destination of the medium to the escape tray 506. Upon receiving the instruction, the CPU circuit unit 701 instructs the printout destination control unit 705 to switch the destination to the escape tray 506.

In addition, to remove the media stacked on the lift table 508, the following mediating process is performed. That is, the CPU circuit unit 605 instructs the CPU circuit unit 701 to move the slide door 502 upward. Upon receiving the instruction, the CPU circuit unit 701 instructs the slide door control unit 706 to move the slide door 502 upward. Thereafter, the CPU circuit unit 605 instructs the CPU circuit unit 701 to move the lift table 508 downward.

Upon receiving the instruction, the CPU circuit unit 701 instructs the lift table control unit 707 to move the lift table 508 downward. Finally, the CPU circuit unit 605 instructs the CPU circuit unit 701 to move the eject table 509 forward. Upon receiving the instruction, the CPU circuit unit 701 instructs the eject table control unit 708 to move the eject table 509 forward.

The button press detection unit 709 performs the mediating process in the following manner. That is, if, for example, the operator presses the button 501, the button press detection unit 709 sends, to the CPU circuit unit 701, a message indicating that the button 501 is pressed. Upon receiving the message, the CPU circuit unit 701 sends, to the CPU circuit unit 605, a message indicating that the button 501 is pressed.

As described above, the instructions sent to the printout destination control unit 705, the slide door control unit 706, the lift table control unit 707, and the eject table control unit 708 and the messages sent from the button press detection unit 709 can be centrally controlled by the CPU circuit unit 605.

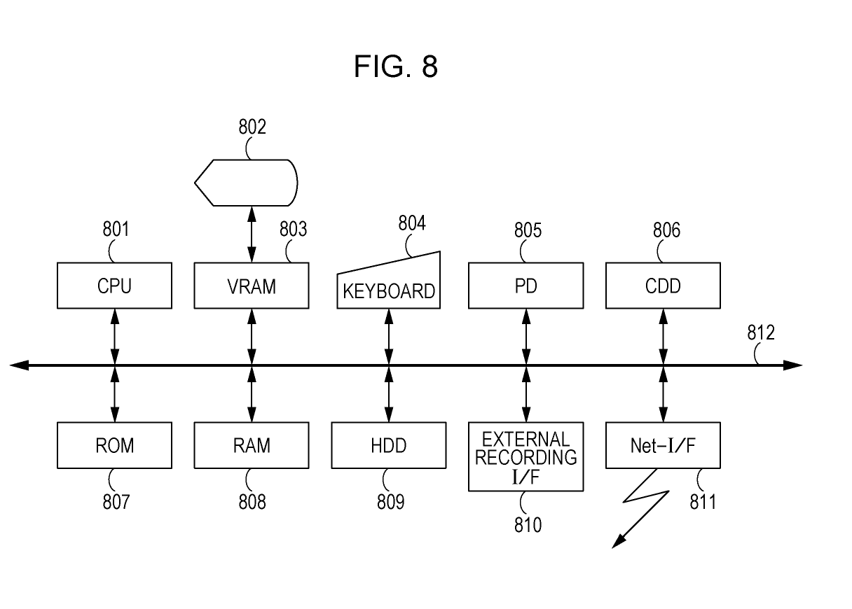

FIG. 8 is a block diagram of the hardware configurations of the information processing apparatus 102 and the information processing apparatus 103 illustrated in FIG. 1.

As illustrated in FIG. 8, a CPU 801 controls the devices connected thereto on the basis of programs stored in a ROM 807, an HDD 809, and a compact disc drive (CDD) 806.

A display unit 802 displays user interface information, such as a window, an icon, a message, and a menu. A video random access memory (VRAM) 803 allows an image to be displayed on the display unit 802 to be rendered therein. Image data generated in the VRAM 803 is transferred to the display unit 802 in a predetermined manner. Thus, the image is displayed on the display unit 802.

A keyboard 804 includes a variety of keys used for inputting characters. A pointing device (PD) 805 is used to select an object, such as an icon or a menu, displayed in a display screen of the display unit 802.

The CDD 806 is a device to read and write a variety of control programs and data from and to a recording medium, such as a CD-ROM or a CD-R. Note that the CDD 806 may be replaced with a DVD drive.

The ROM 807 stores a variety of control programs and data. A RAM 808 serves as a work area of the CPU 801, a data save area used in error processing, and a control program load area.

For example, the information processing apparatus 102 has a function of performing RIP on digital data and transmitting the data to the printing apparatus 101. The program for the function is stored in the ROM 807. When RIP is performed, the information processing apparatus 102 uses the RAM 808 as the work area of the CPU 801. In addition, the information processing apparatus 103 has a function of transmitting, to the information processing apparatus 102, digital data in the form of a print job. The program for the function is stored in the ROM 807. When the transmission processing is performed, the information processing apparatus 102 uses the RAM 808 as the work area of the CPU 801.

The HDD 809 serves as an internal recording unit. The HDD 809 stores a variety of programs and data items. An external recording I/F 810 reads and writes data from and to an external recording medium, such as a USB memory.

A network interface (Net-I/F) 811 can communicate data with the printing apparatus 101, the information processing apparatus 102, and the information processing apparatus 103 via the network 104. A CPU bus 812 includes an address bus, a data bus, and a control bus.

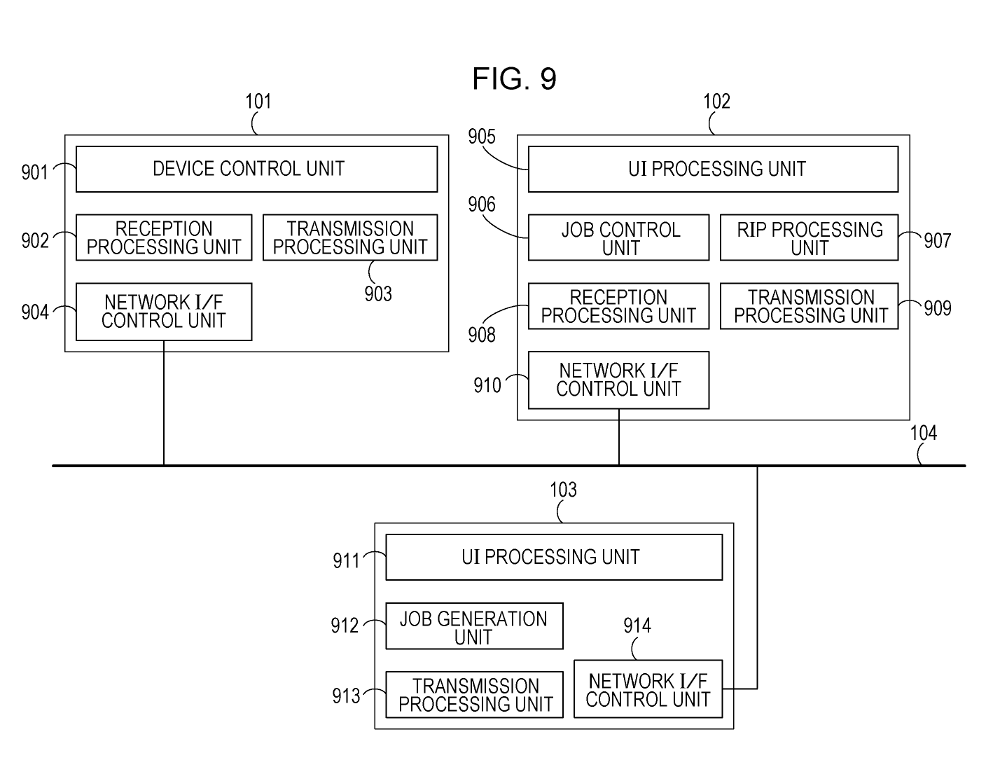

FIG. 9 is a block diagram of the software configurations of the printing apparatus 101, the information processing apparatus 102, and the information processing apparatus 103 illustrated in FIG. 1.

As illustrated in FIG. 9, a device control unit 901, a reception processing unit 902, a transmission processing unit 903, and a network I/F control unit 904 are software modules that are executable by the CPU circuit unit 605 of the printing apparatus 101. Accordingly, the functions of the modules are realized by the CPUs included in the devices that executes the software module.

In addition, a UI processing unit 905, a job control unit 906, a RIP processing unit 907, a reception processing unit 908, a transmission processing unit 909, and a network I/F control unit 910 are software modules that are executable by the CPU 801 of the information processing apparatus 102.

Furthermore, a UI processing unit 911, a job generation unit 912, a transmission processing unit 913, and a network I/F control unit 914 are software modules that are executable by the CPU 801 of the information processing apparatus 103.

The device control unit 901 performs the following processes: a print function of the image forming unit 203 and removal of printed media stacked on the lift table 508 of the high-capacity stacker 204. For example, when removing printed media stacked on the lift table 508, the device control unit 901 controls the stacker control unit 610 so that the slide door 502 moves upward, the lift table 508 moves downward, and the eject table 509 moves forward.

The reception processing unit 902 receives an image to be printed that is subjected to RIP of the information processing apparatus 102 via the network I/F control unit 904. Thereafter, the reception processing unit 902 delivers the image to the device control unit 901 on a page-by-page basis. In addition, the reception processing unit 902 receives a request for removing printed media stacked on the lift table 508 and delivers the request to the device control unit 901.

Upon receiving, from the stacker control unit 610, a message indicating that the button 501 of the high-capacity stacker 204 is pressed, the transmission processing unit 903 delivers the message to the reception processing unit 908 of the information processing apparatus 102 via the network I/F control unit 904.

The network I/F control unit 904 controls the network I/F 612. In addition, the network I/F control unit 904 performs data communication between the printing apparatus 101 and the information processing apparatus 102 via the network 104 in cooperation with the network I/F control unit 910.

The UI processing unit 905 displays a job management application screen and a system status screen on the display unit 802 of the information processing apparatus 102. In addition, the UI processing unit 905 delivers, to the job control unit 906, a stack eject request received through the system status screen.

The job control unit 906 manages print jobs submitted to the printing apparatus 101 and performs a job transmission process. More specifically, the job control unit 906 starts, suspends, and cancels a print job. Furthermore, the job control unit 906 delivers the stack eject request received from the UI processing unit 905 to the transmission processing unit 909. The RIP processing unit 907 performs RIP processing on data to be printed on a page-by-page basis.

The reception processing unit 908 receives, from the printing apparatus 101, a message indicating that the button 501 of the high-capacity stacker 204 is pressed via the network I/F control unit 910 and delivers the message to the job control unit 906. In addition, the reception processing unit 908 delivers the print job received from the information processing apparatus 103 to the job control unit 906 via the network I/F control unit 910.

The transmission processing unit 909 delivers the RIP image to the reception processing unit 902 of the printing apparatus 101 via the network I/F control unit 910 on a page-by-page basis. In addition, the transmission processing unit 909 delivers the stack eject request received from the job control unit 906 to the reception processing unit 902 of the printing apparatus 101 via the network I/F control unit 910.

The network I/F control unit 910 controls the Net-I/F 811. In addition, the network I/F control unit 910 performs data communication with the printing apparatus 101, the information processing apparatus 102, and the information processing apparatus 103 via the network 104 in cooperation with the network I/F control unit 904 and the network I/F control unit 914.

The UI processing unit 911 displays a job setting screen on the display unit 802 of the information processing apparatus 103. In addition, the UI processing unit 911 delivers, to the job generation unit 912, an instruction to generate a print job.

Upon receiving the instruction from the UI processing unit 911, the job generation unit 912 generates a print job and delivers print data of the job to the transmission processing unit 913. The transmission processing unit 913 delivers the print job to the reception processing unit 908 of the information processing apparatus 102 via the network I/F control unit 914.

The network I/F control unit 914 controls the Net-I/F 811. In addition, the network I/F control unit 914 performs data communication between the information processing apparatus 102 and the information processing apparatus 103 via the network 104 in cooperation with the network I/F control unit 910.

In such a configuration, when the information processing apparatus 103 sends a print job and if the printing apparatus 101 performs RIP processing and the printing apparatus 101 performs a printing process, the following processes are performed.

That is, the job generation unit 912 of the information processing apparatus 103 generates a job in accordance with the job settings set by the UI processing unit 911. Thereafter, the job generation unit 912 sends, to the job control unit 906, a print job including print data and the job setting information using the transmission processing unit 913 first.

Subsequently, the job control unit 906 of the information processing apparatus 102 renders the received print data using the RIP processing unit 907 on a page-by-page basis and sends the RIP image to the device control unit 901 using the transmission processing unit 909.

In addition, upon transmitting the RIP image, the job control unit 906 transmits the job setting information to the device control unit 901 via the network I/F control unit 910. Subsequently, the device control unit 901 of the printing apparatus 101 acquires the received RIP image and delivers the image data to the image signal control unit 603. In addition, the device control unit 901 receives the job setting information.

Subsequently, the device control unit 901 sends instructions related to the destination of printed media and the paper feed tray to the printer control unit 604, the external paper feed unit controller 609, and the stacker control unit 610 on the basis of the job setting information. When sending the instructions, the device control unit 901 sends an instruction to the image signal control unit 603 so that the image data is delivered to the printer control unit 604.

In addition, in such a configuration, when printed media stacked on the lift table 508 of the high-capacity stacker 204 are removed, the following processing is performed.

That is, upon receiving a stack eject request through the system status screen, the UI processing unit 905 of the information processing apparatus 102 sends a stack eject request to the job control unit 906. The job control unit 906 controls the job in accordance with the current job status and, subsequently, delivers the stack eject request to the device control unit 901 via the transmission processing unit 909.

Subsequently, the device control unit 901 of the printing apparatus 101 performs control in accordance with the received stack eject request so that the slide door 502 moves upward, the lift table 508 moves downward, and the eject table 509 moves forward.

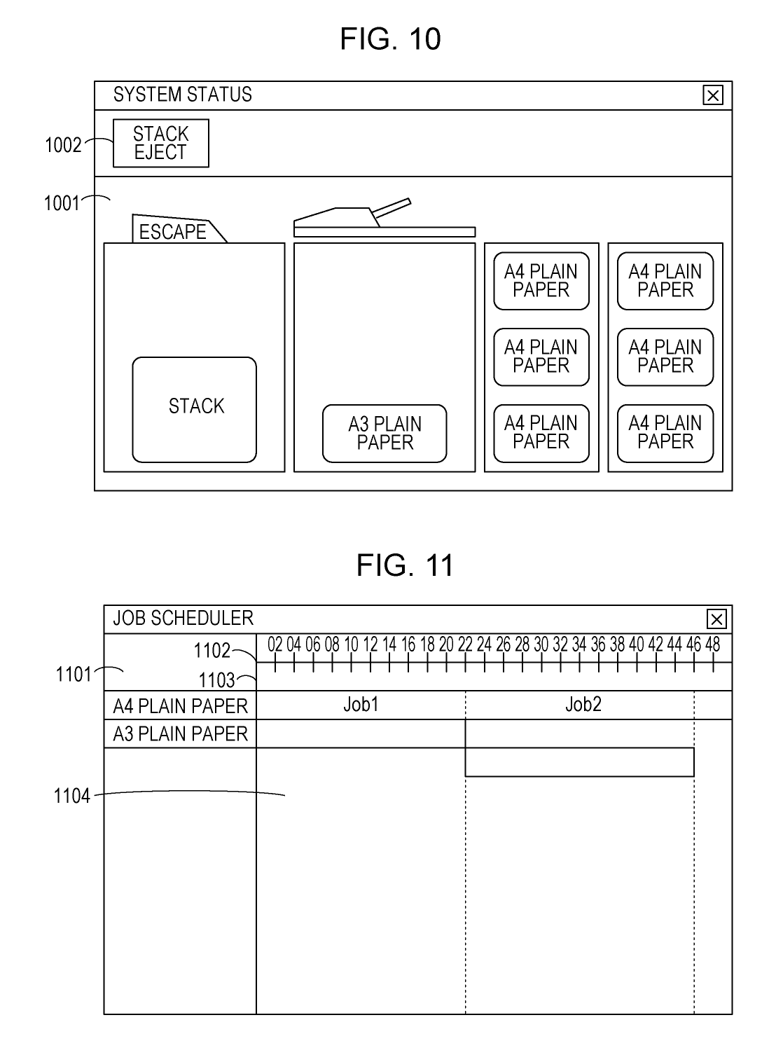

FIG. 10 illustrates an example of a UI screen displayed on the display unit 802 of the information processing apparatus 102 illustrated in FIG. 1. The example of a UI screen is a system status screen related to the printing apparatus 101. The system status screen is displayed in order to control the status of the paper feed tray and the sheet output tray of the printing apparatus 101.

As illustrated in FIG. 10, the statuses of the paper feed tray and the sheet output tray in accordance with the configuration of the printing apparatus 101 are displayed in a display area 1001. Note that in FIG. 10, for each of the external paper feed unit 201 and the external paper feed unit 202, the paper feed tray 301, the paper feed tray 302, and the paper feed tray 303 are displayed.

In addition, all of the paper feed trays are filled with A4-size plain paper. Furthermore, for the image forming unit 203, the paper feed tray 417 is displayed, and the paper feed tray 417 is filled with A3-size plain paper. Still furthermore, for the high-capacity stacker 204, the escape tray 506 and the lift table 508 are displayed.

A stack eject button 1002 is pressed when printed media stacked on the lift table 508 of the high-capacity stacker 204 are removed from the high-capacity stacker 204. At normal times, the stack eject button 1002 is grayed out and, thus, an operator cannot press the button. If a section having “STACK” in the display area 1001 is pressed, the stack eject button 1002 is not grayed out and, thus, the operator can press the stack eject button 1002.

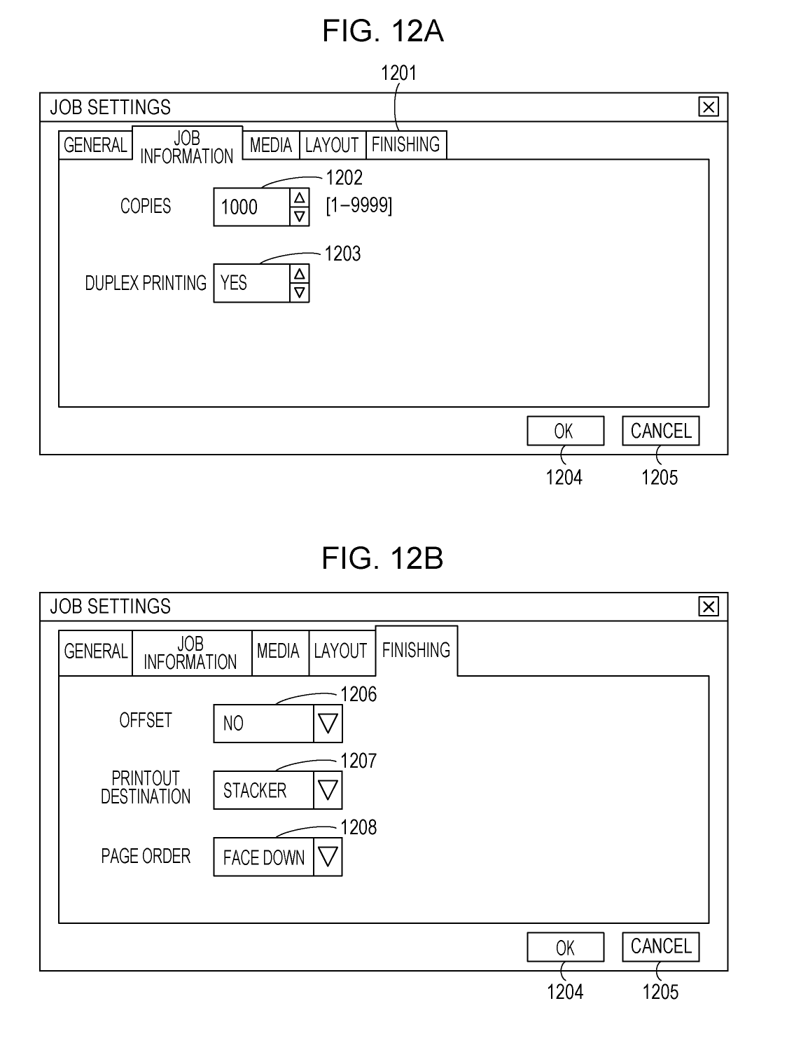

FIG. 11 illustrates an example of a UI screen displayed on the display unit 802 of the information processing apparatus 102 illustrated in FIG. 1. The example of a UI screen is a job scheduling screen displayed on the display unit 802 of the information processing apparatus 102. Note that a job for printing in the printing apparatus 101 is managed using the job scheduling screen illustrated in FIG. 11.

As illustrated in FIG. 11, media required for scheduled jobs are displayed in a required media button group area 1101 in a list format. For example, A4 plain paper is required for Job 1, and A3 plain paper is required for Job 2. Note that the number of buttons displayed in the required media button group area 1101 varies in accordance with the number of print jobs to be scheduled. For example, if Job 1 is completed, a job that uses A4 plain paper disappears and, therefore, “A4 plain paper” is not displayed in the required media button group area 1101.

A time axis 1102 starts at a present time. The time axis 1102 extends from the left to the right. The unit time is a minute. A job name entry 1103 indicates the name of a print job. In FIG. 11, Job 1 and Job 2 are displayed. A job status entry 1104 indicates the type of media required for the print job and an estimated point in time at which the job is completed.

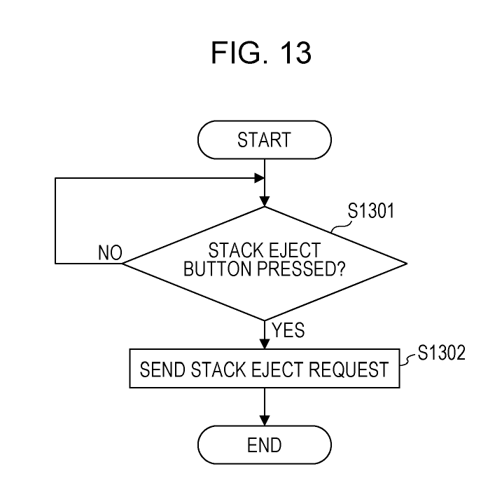

FIGS. 12A and 12B illustrate examples of a UI screen displayed on the display unit 802 of the information processing apparatus 102 illustrated in FIG. 1. The examples of a UI screen are job setting screens displayed on the display unit 802 of the information processing apparatus 103.

As illustrated in FIG. 12A, a tab group 1201 includes five job setting items: “General”, “Job Information”, “Media”, “Layout”, and “Finishing”. In FIG. 12A, the setting items of “Job Information” are displayed.

The settings in the tab “Job Information” are applied to all print jobs. The “copies” setting 1202 indicates the number of copies when printing the print data. In FIG. 12A, 1000 copies are printed. The “Duplex Printing” setting 1203 indicates whether the print data is printed in a duplex mode. In FIG. 12A, the print data is printed in a duplex mode.

The OK button 1204 is used to accept the settings input in the job setting screen as the settings for the job. The “Cancel” button 1205 is used to cancel the settings input in the job setting screen. Note that if the OK button 1204 or the “Cancel” button 1205 is pressed, the job setting screen is closed.

The setting items of “Finishing” setting are displayed in FIG. 12B.

In FIG. 12B, the “Finishing” tab includes the sheet output settings. “Offset” setting 1206 has a pull down menu used to select whether sheets are offset when the sheets are output. In FIG. 12B, non-offset setting is selected.

A printout destination setting 1207 is used to select the destination of printed media. This setting is made by selecting “Escape Tray” (not illustrated) or “Stacker”. In FIG. 12B, “Stacker” is selected. According to the present exemplary embodiment, “Stacker” indicates the lift table 508 of the high-capacity stacker 204.

“Page Order” setting 1208 indicates whether a first page of the print job is output face down or face up. This setting is made by selecting “Face Up” (not illustrated) or “Face Down”. An OK button 1204 and the cancel button 1205 are similar to those in FIG. 12A and, therefore, descriptions are not repeated.

The case in which in the printing apparatus having the above-described configuration, a request for removing printed media stacked on the lift table 508 from the high-capacity stacker 204 is received during outputting the printed media onto the lift table 508 of the high-capacity stacker 204 is discussed below. Hereinafter, such a removal request is referred to as a “stack eject request”.

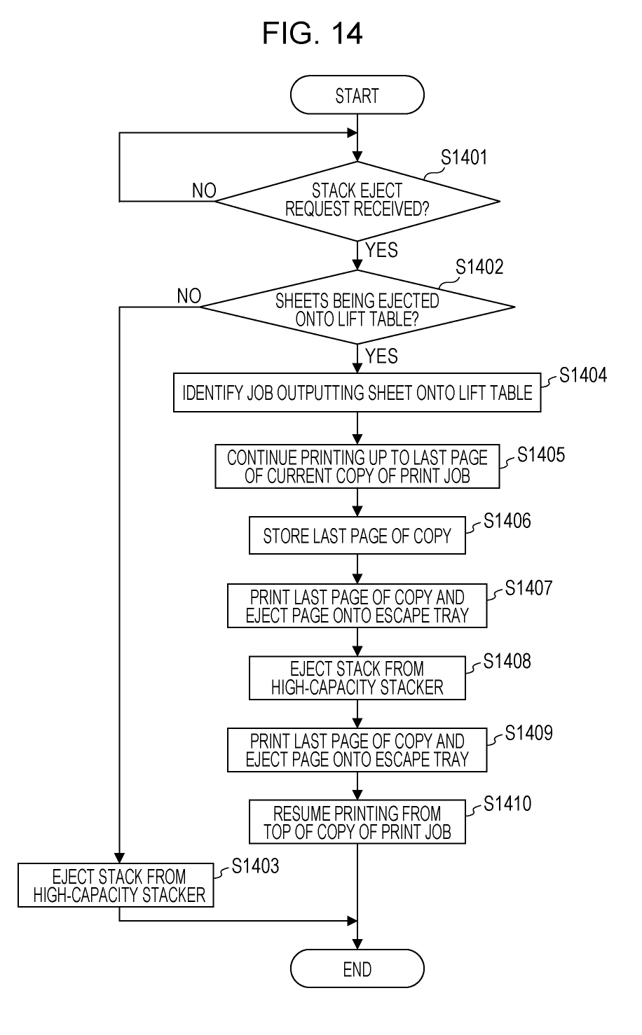

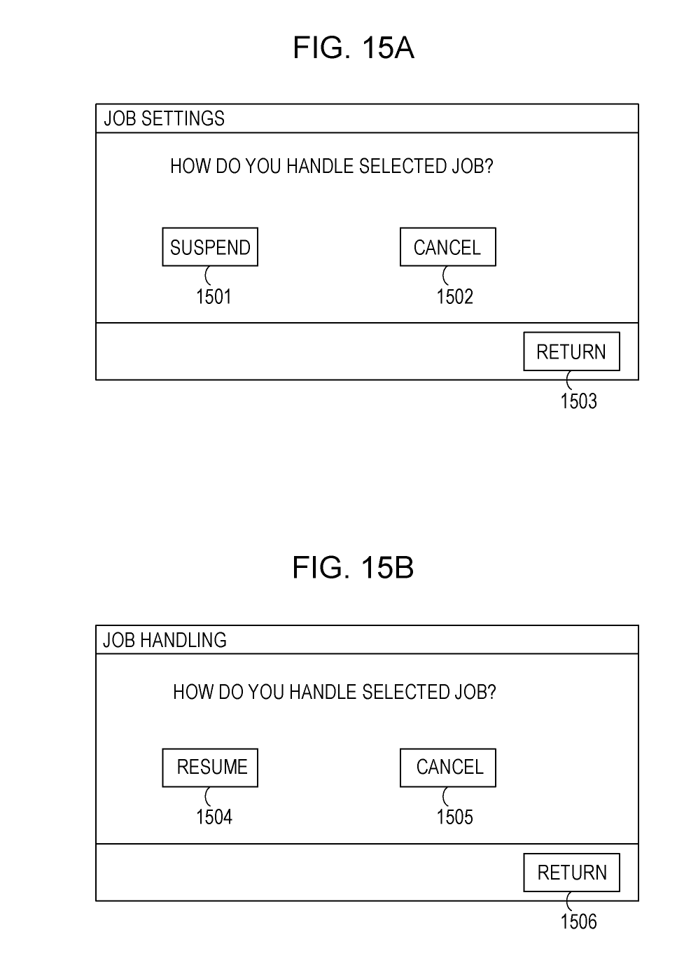

According to the present exemplary embodiment, when a stack eject request is received, a sample print is produced before and after the stack eject. Note that according to the first exemplary embodiment, the operator submits a print job to the information processing apparatus 102 after setting up the job setting screen displayed on the display unit 802 of the information processing apparatus 103 in the manner as illustrated in FIGS. 12A and 12B. Hereinafter, descriptions are made with reference to the flowcharts illustrated in FIGS. 13 and 14.

FIG. 13 is a flowchart illustrating a technique for controlling the image information apparatus according to the present exemplary embodiment. In this example, processes are performed by the information processing apparatus 102 illustrated in FIG. 1. The steps of the process are realized by the CPU 801 that executes a control program stored in the ROM 807. The following description is made with reference to the software modules.

In step S1301, the UI processing unit 905 determines whether the operator presses the stack eject button 1002 in the UI screen illustrated in FIG. 10. If the UI processing unit 905 determines that the stack eject button 1002 is pressed, the processing performed by the UI processing unit 905 proceeds to step S1302. However, if the UI processing unit 905 determines that the stack eject button 1002 is not pressed, the processing performed by the UI processing unit 905 returns to step S1301.

In step S1302, the UI processing unit 905 sends a stack eject request to the job control unit 906. Thereafter, the UI processing unit 905 completes the processing.

FIG. 14 is a flowchart illustrating a technique for controlling the printing apparatus according to the present exemplary embodiment. This process is an example of the process performed by the printing apparatus 101 illustrated in FIG. 1. The steps of this process are realized by the CPU 606 that executes a control program stored in the ROM 607. In addition, the process illustrated in FIG. 14 corresponds to the process of the device control unit 901 performed by the CPU 606. Description below is made with reference to the software modules.

In step S1401, the processing loops in order to detect whether a stack eject request is received. If the device control unit 901 determines that a stack eject request is received in this loop, the processing proceeds to step S1402. However, if the device control unit 901 determines that a stack eject request is not received, the processing returns to step S1401.

In step S1402, the device control unit 901 determines whether printed sheets of the print job are being output onto the lift table 508. More specifically, if a print job that is currently in a print mode is found, the device control unit 901 can determine whether the sheets are being output onto the lift table 508 by referring to the printout destination setting 1207 for the print job in a print mode. That is, if a print job currently in a print mode is not found or if the printout destination setting 1207 of the print job currently in a print mode indicates an escape tray, the processing performed by the device control unit 901 proceeds to step S1403. However, if the printout destination setting 1207 of the print job currently in a print mode indicates a stacker, the processing proceeds to step S1404.

In step S1403, the device control unit 901 submits a stack eject request to the high-capacity stacker 204. Thus, the high-capacity stacker 204 moves the slide door 502 upward and moves the sheets stacked on the lift table 508 onto the eject table 509 so as to remove the sheet stack from the high-capacity stacker 204.

In step S1404, the device control unit 901 identifies the print job currently outputting sheets onto the lift table 508, and the processing proceeds to step S1405.

In step S1405, the device control unit 901 performs printing up to the last page of the current copy for the identified print job. For example, let a print job have image data for 10 pages and print 1000 copies. Then, the device control unit 901 prints images on the sheets until page 10 of copy 500 is printed on the basis of the RIP image for the pages. Thereafter, the device control unit 901 suspends the print job, and the processing proceeds to step S1406.

In step S1406, the device control unit 901 stores, in the HDD 613, the RIP image of the last page of the identified print job. Thereafter, the processing proceeds to step S1407. In step S1407, the device control unit 901 prints an image on a sheet on the basis of the stored RIP image of the last page of the print job and outputs the printed sheet onto the escape tray 506. Thereafter, the processing proceeds to step S1408.

In step S1408, the device control unit 901 submits a stack eject request to the high-capacity stacker 204. Thereafter, the processing proceeds to step S1409. Upon receiving the stack eject request, the high-capacity stacker 204 moves the sheets stacked on the lift table 508 to the eject table 509 in the above-described manner to remove the sheet stack from the high-capacity stacker 204. At that time, it takes several ten seconds from the time the high-capacity stacker 204 moves the sheet stack until the high-capacity stacker 204 raises the lift table 508 to the position of a sheet output port. If a sensor (not illustrated) detects that the lift table 508 is lifted up to a position at which the lift table 508 can stack sheets output from the sheet output port of the stack path 505 of the high-capacity stacker 204, printing for the print job is resumed. Note that printing for the print job may be resumed after a resume instruction is received from the user.

In step S1409, the device control unit 901 prints an image on the basis of the RIP image of the last page of the print job stored in the HDD 613 and outputs the sheet onto the escape tray 506. Thereafter, the processing proceeds to step S1410. That is, the image of the last page of the identified print job is printed three times. In step S1405, first printing is performed, and the sheet is output onto the lift table 508 specified as the destination of printed sheet. Thereafter, second printing is performed in step S1406, and the sheet is output onto the escape tray 506. Subsequently, third printing is performed in step S1409, and the sheet is output onto the escape tray 506.

In step S1410, the device control unit 901 resumes the suspended job and prints an image on a sheet on the basis of the RIP image of the subsequent page. More specifically, in the above-described example, images are printed on sheets on the basis of the RIP images of a first page of copy 501 and the subsequent pages, and the sheets are output onto the lift table 508.

As described above, according to the present exemplary embodiment, a sample print of the same page is automatically produced before and after stack eject. Accordingly, by comparing the two sample prints output onto the escape tray 506 with each other with the naked eye, the operator can examine a tint variation.

Note that according to the present exemplary embodiment, the process indicated by the flowchart in FIG. 13 may be replaced with the process performed when the button 501 of the high-capacity stacker 204 is pressed. In such a case, the stack eject request is realized by receiving a button press message from the button press detection unit 709 using the device control unit 901. The flowchart of that process is substantially the same as that in FIG. 13. Therefore, description of the process is not repeated.

In addition, while the present exemplary embodiment has been described with reference to a job sent from the information processing apparatus 103, the present exemplary embodiment can be applied to a copy job for printing an image scanned by the scanner 402 of the printing apparatus 101. In such a case, the above-described screen can be displayed on an operation unit of the printing apparatus 101 and, thereafter, an instruction can be received from a user.

### Second Exemplary Embodiment

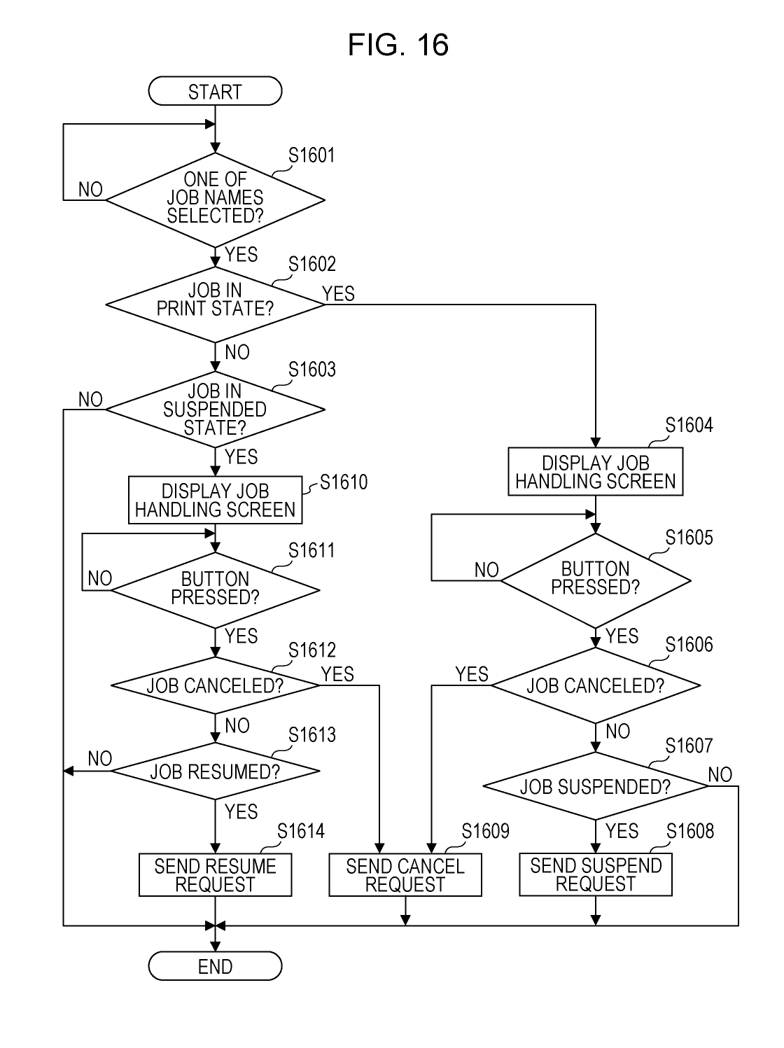

A second exemplary embodiment is described with reference to the case in which a sample print is produced when a print job is suspended or canceled due to an instruction from a user. Note that like the first exemplary embodiment, a print job is sent to the information processing apparatus 102 after the operator sets up the job setting screen using the display unit 802 of the information processing apparatus 103 as illustrated in FIGS. 12A and 12B. The present exemplary embodiment is described below with reference to FIGS. 15A, 15B, 16, and 17.

FIGS. 15A and 15B illustrate examples of UI screens displayed on the display unit 802 of the information processing apparatus 102 illustrated in FIG. 1. These UI screens are examples of job handling screens.

The screens illustrated in FIGS. 15A and 15B are displayed when the operator presses a job name displayed in the job name entry 1103 of the job scheduling screen.

For example, when the user presses a section having “Job 1” or “Job 2” displayed therein illustrated in FIG. 11, one of the UI screens is displayed. That is, if the selected job is in a print mode, the screen of FIG. 15A is displayed on the display unit 802 of the information processing apparatus 102. However, if the selected job is in a suspended mode, the screen of FIG. 15B is displayed on the display unit 802 of the information processing apparatus 102. Note that if the job is in neither a print mode nor a suspended mode, the job scheduling screen remains displayed.

As illustrated in FIG. 15A, a “suspend” button 1501 is pressed to suspend the selected job during the processing of the job. In addition, a “cancel” button 1502 is pressed to cancel the selected job.

Upon receiving a message indicating that the “suspend” button 1501 or the “cancel” button 1502 is pressed, the UI processing unit 905 sends, to the job control unit 906, a job cancel request or a job cancel request regarding the selected job. Thereafter, the UI processing unit 905 changes the screen displayed on the display unit 802 back to the job scheduling screen.

A “return” button 1503 is used to re-display the job scheduling screen. By pressing the “return” button 1503, the job scheduling screen can be re-displayed without suspending or canceling the selected job.

As illustrated in FIG. 15B, a “resume” button 1504 is used to change back the selected job from a suspended state to a print state. A “cancel” button 1505 is used to cancel the selected job.

If the “resume” button 1504 or the “cancel” button 1505 is pressed, the UI processing unit 905 sends, to the job control unit 906, a resume request or a cancel request regarding the selected job. Thereafter, the UI processing unit 905 changes the displayed screen on the display unit 802 to the job scheduling screen.

A “return” button 1506 is used to re-display the job scheduling screen. By pressing the “return” button 1506, the job scheduling screen can be re-displayed without resuming or canceling the selected job.

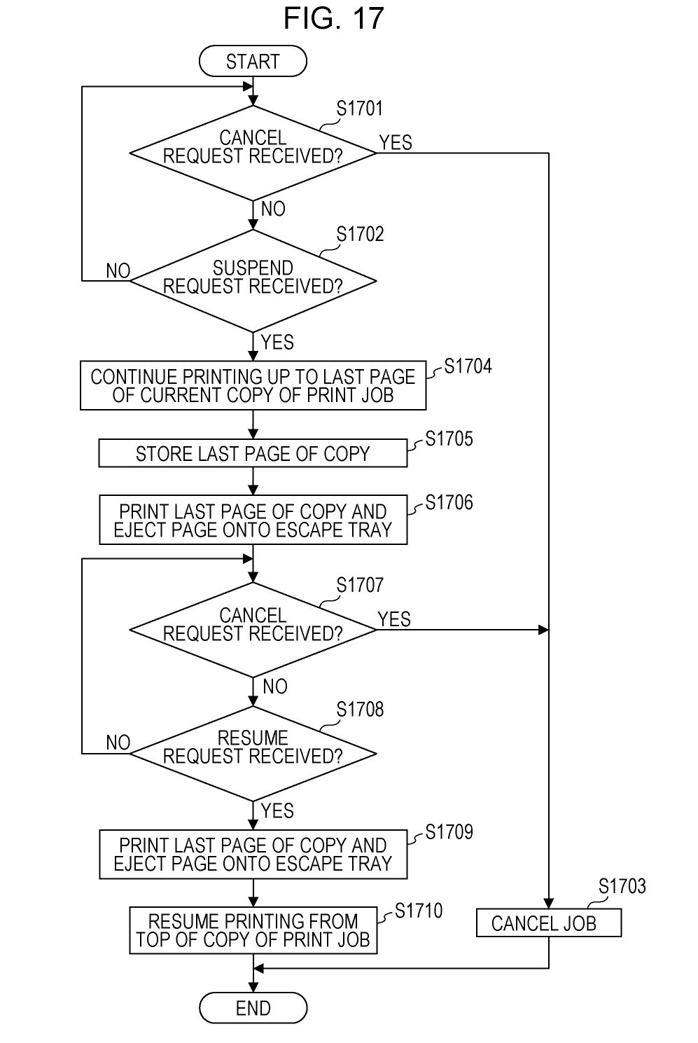

FIG. 16 is a flowchart illustrating a technique for controlling an image information apparatus according to the present exemplary embodiment. In this example, processes are performed by the information processing apparatus 102 illustrated in FIG. 1. The steps of the process are realized by the CPU 606 that executes a control program stored in the ROM 607. In addition, the process illustrated in FIG. 16 corresponds to the process of the UI processing unit 905 performed by the CPU 606. The following description is made with reference to the software modules.

In step S1601, it is determined whether the operator presses a job name displayed in the job name entry 1103 of the job scheduling screen. If the UI processing unit 905 determines that a job name displayed in the job name entry 1103 of the job scheduling screen is pressed, the processing proceeds to step S1602. However, if the UI processing unit 905 determines that the job name displayed in the job name entry 1103 of the job scheduling screen is not pressed, the processing returns to step S1601.

In step S1602, the UI processing unit 905 queries the job control unit 906 about the mode of the selected job to determine whether the job is in a print mode using the response from the job control unit 906. If the UI processing unit 905 determines that the job is in a print mode, the processing proceeds to step S1602. However, if the UI processing unit 905 determines that the job is not in a print mode, the processing proceeds to step S1603, where the UI processing unit 905 determines whether the selected job is in a suspended mode. If the UI processing unit 905 determines that the selected job is in a suspended mode, the processing proceeds to step S1610. However, if the UI processing unit 905 determines that the selected job is not in a suspended mode, the processing is completed.

The case in which the selected job is in a print mode is described first.

In step S1604, the UI processing unit 905 displays the job handling screen illustrated in FIG. 15A on the display unit 802. Thereafter, the processing proceeds to step S1605, where it is determined whether the operator presses any one of the suspend button 1501, the cancel button 1502, and the return button 1503. If the UI processing unit 905 determines that any one of the suspend button 1501, the cancel button 1502, and the return button 1503 is pressed, the processing proceeds to step S1606. However, the UI processing unit 905 determines that none of the suspend button 1501, the cancel button 1502, and the return button 1503 is pressed, the processing returns to step S1605.

In step S1606, the UI processing unit 905 determines whether the cancel button 1502 is pressed. If the UI processing unit 905 determines that the cancel button 1502 is pressed, the processing proceeds to step S1609. However, if the UI processing unit 905 determines that the cancel button 1502 is not pressed, the processing proceeds to step S1607.

In step S1607, the UI processing unit 905 determines whether the suspend button 1501 is pressed. If the UI processing unit 905 determines that the suspend button 1501 is pressed, the processing proceeds to step S1608. However, if the UI processing unit 905 determines that the suspend button 1501 is not pressed, the UI processing unit 905 determines that the return button 1503 is pressed. Thus, the processing is completed.

In step S1608, the UI processing unit 905 sends a suspend request to the printing apparatus 101, and the processing is completed. In step S1609, the UI processing unit 905 sends a cancel request to the printing apparatus 101, and the processing is completed.

The case in which the selected job is in a suspended mode is described next.

In step S1610, the UI processing unit 905 displays the job handling screen illustrated in FIG. 15B on the display unit 802. Thereafter, the processing proceeds to step S1611, where it is determined whether the operator presses any one of the resume button 1504, the cancel button 1505, and the return button 1506. If the UI processing unit 905 determines that any one of the resume button 1504, the cancel button 1505, and the return button 1506 is pressed, the processing proceeds to step S1612. However, the UI processing unit 905 determines that none of the resume button 1504, the cancel button 1505, and the return button 1506 is pressed, the processing returns to step S1611.

In step S1612, the UI processing unit 905 determines whether the cancel button 1505 is pressed. If the UI processing unit 905 determines that the cancel button 1505 is pressed, the processing proceeds to step S1609. However, if the UI processing unit 905 determines that the cancel button 1505 is not pressed, the processing proceeds to step S1613.

In step S1613, the UI processing unit 905 determines whether the resume button 1504 is pressed. If the UI processing unit 905 determines that the resume button 1504 is pressed, the processing proceeds to step S1614. However, if the UI processing unit 905 determines that the resume button 1504 is not pressed, that is, the return button 1506 is pressed. Accordingly, the UI processing unit 905 completes the processing. In step S1614, the UI processing unit 905 sends a resume request to the printing apparatus 101, and the processing is completed.

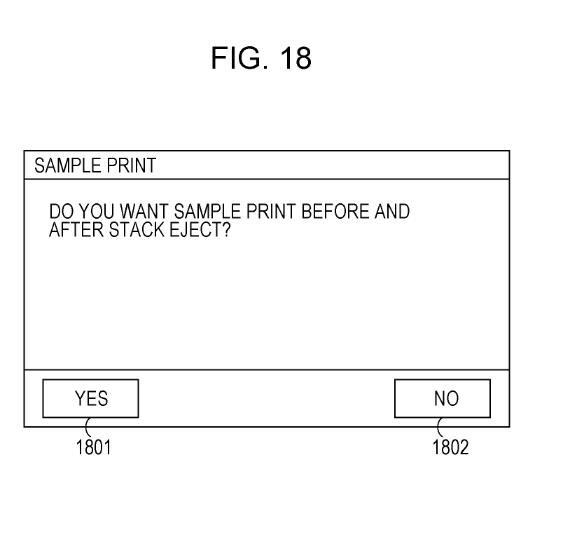

FIG. 17 is a flowchart illustrating a technique for controlling the printing apparatus according to the present exemplary embodiment. This process is an example of the process performed by the printing apparatus 101 illustrated in FIG. 1. The steps of this process are realized by the CPU 606 that executes a control program stored in the ROM 607. The following description is made with reference to the software modules.

In steps S1701 and S1702, the device control unit 901 determines whether the operator presses the suspend button 1501 or the cancel button 1502 illustrated in FIG. 15A. More specifically, the device control unit 901 determines whether a suspend request is received from the UI processing unit 905 and whether a cancel request is received from the UI processing unit 905. The steps are described below with reference to the accompanying drawings.

If, in step S1701, the device control unit 901 determines that a cancel request is received from the UI processing unit 905, the processing proceeds to step S1703. However, if the device control unit 901 determines that a cancel request is not received from the UI processing unit 905, the processing proceeds to step S1702.

If, in step S1702, the device control unit 901 determines that a suspend request is received from the UI processing unit 905, the processing proceeds to step S1704. However, if the device control unit 901 determines that a suspend request is not received from the UI processing unit 905, the processing returns to step S1701.

In step S1703, the device control unit 901 cancels the job. Thus, printing is stopped. The processes performed in steps S1704, S1705, and S1706 are similar to the processes performed in steps S1405, S1406, and S1407 of the first exemplary embodiment, respectively. Accordingly, descriptions of the processes are not repeated.

In steps S1707 and S1708, processes to be performed when the operator presses the resume button 1504 or the cancel button 1505 illustrated in FIG. 15B are performed. More specifically, it is determined whether a resume request is received from the UI processing unit 905 and whether a cancel request is received from the UI processing unit 905.

If, in step S1707, the device control unit 901 determines that a cancel request is received from the UI processing unit 905, the processing proceeds to step S1703. However, if the device control unit 901 determines that a cancel request is not received from the UI processing unit 905, the processing proceeds to step S1708. If, in step S1708, the device control unit 901 determines that a resume request is received from the UI processing unit 905, the processing proceeds to step S1709. However, if the device control unit 901 determines that a resume request is not received from the UI processing unit 905, the processing returns to step S1707. The processes performed in steps S1709 and S1710 are similar to the processes performed in steps S1409 and S1410 of the first exemplary embodiment, respectively. Accordingly, descriptions of the processes are not repeated.

By performing the above-described processes, a sample print of the same page is automatically produced before and after suspension of the print job. Accordingly, by comparing the two sample prints output onto the escape tray 506 with each other with the naked eye, the operator can examine a tint variation. In addition, if the job is canceled during a suspended mode of the job, a sample print is not produced. Accordingly, print media are not wasted.

### Third Exemplary Embodiment

A third exemplary embodiment is described with reference to the case in which when a stack eject request is received during outputting sheets onto the lift table 508 of the high-capacity stacker 204, an operator can select whether a sample print is produced before and after stack eject. Note that according to the present exemplary embodiment, a print job is sent to the information processing apparatus 102 after the operator sets up the job setting screen using the display unit 802 of the information processing apparatus 103 as illustrated in FIGS. 12 A and 12B.

Since the process performed when the operator performs stack eject is similar to that of the first exemplary embodiment, description of the process is not repeated.

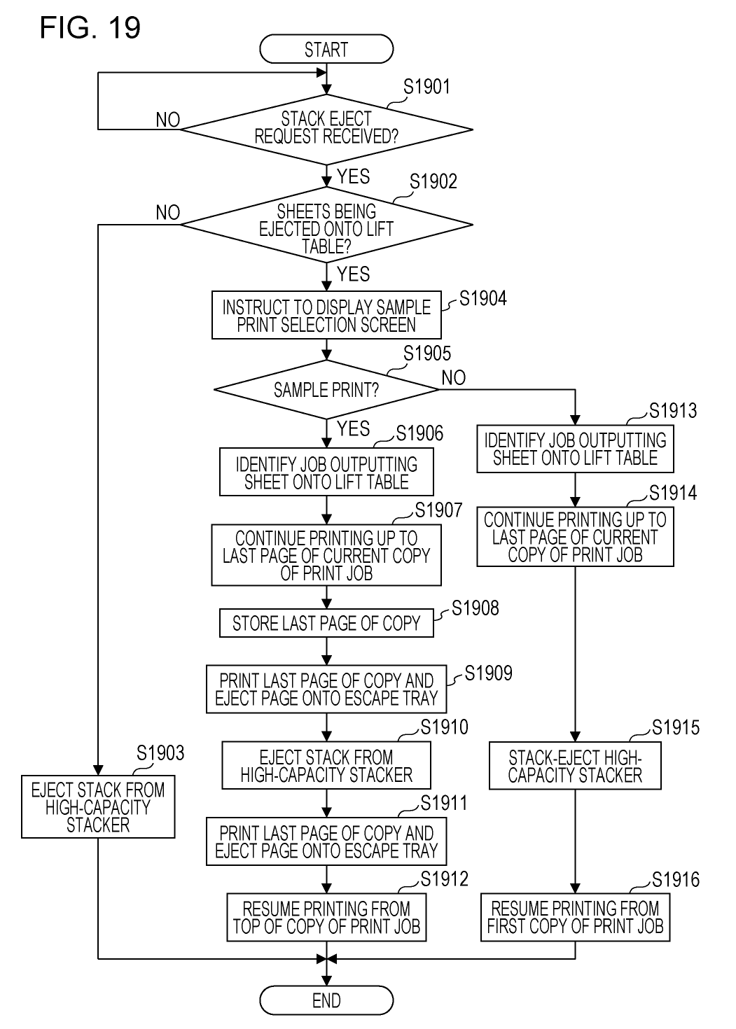

FIG. 18 illustrates an example of a UI screen displayed on the display unit 802 of the information processing apparatus 102 illustrated in FIG. 1. This UI screen is an example of a sample print selection screen.

A Yes button 1801 in the sample print selection screen illustrated in FIG. 18 is used to produce a sample print before and after stack eject. A No button 1802 is used not to produce a sample print before and after stack eject. If the yes button 1801 or the no button 1802 is pressed, the UI processing unit 905 sends, to the job control unit 906, a message indicating that a sample print is produced or not. Thereafter, the UI processing unit 905 stops displaying the sample print selection screen.

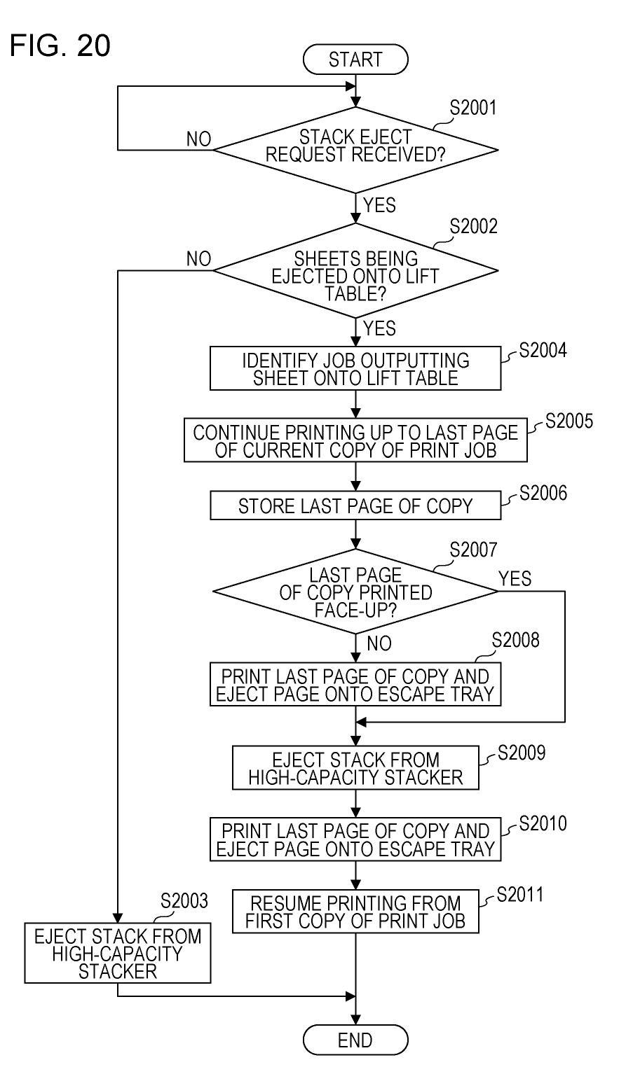

FIG. 19 is a flowchart illustrating a technique for controlling a printing apparatus according to the present exemplary embodiment. In this example, processes are performed by the printing apparatus 101 illustrated in FIG. 1. The steps of the process are realized by the CPU 606 that executes a control program stored in the ROM 607. In addition, the following description is made with reference to the software modules.

In step S1901, the device control unit 901 determines whether a stack eject request is received. If the device control unit 901 determines that a stack eject request is received, the processing proceeds to step S1902. However, if the device control unit 901 determines that a stack eject request is not received, the processing returns to step S1901.

In step S1902, the device control unit 901 determines whether the print job is outputting sheets onto the lift table 508. More specifically, if a print job currently in a print mode is found, the device control unit 901 can determine whether the sheets are being output onto the lift table 508 by referring to the printout destination setting 1207 for the print job in progress. That is, if a print job currently in a print mode is not found or if the printout destination setting 1207 of the print job currently in a print mode indicates an escape tray, the processing performed by the device control unit 901 proceeds to step S1903. However, if the printout destination setting 1207 of the print job currently in a print mode indicates a stacker, the processing proceeds to step S1904.

In step S1904, the device control unit 901 instructs the UI processing unit 905 to display the sample print selection screen illustrated in FIG. 18. Upon receiving, from the UI processing unit 905, information indicating which one of the yes button 1801 and the no button 1802 is pressed by the operator, the processing proceeds to step S1905.

In step S1905, the device control unit 901 determines whether information indicating that the yes button 1801 is pressed in order to produce a sample print is received from the UI processing unit 905. If the device control unit 901 determines that the yes button 1801 is pressed, the processing proceeds to step S1906. However, if the device control unit 901 determines that information indicating that the yes button 1801 is not pressed and the no button 1802 is pressed is received, the processing proceeds to step S1913.

In step S1913, the device control unit 901 identifies the print job outputting sheets onto the lift table 508, and the processing proceeds to step S1914.

In step S1914, the device control unit 901 performs printing up to the last page of the current copy for the identified print job. More specifically, let a print job have image data for 10 pages and print 1000 copies. Then, the device control unit 901 prints images on the sheets until page 10 of copy 500 is printed on the basis of the RIP images for the pages. Thereafter, the device control unit 901 suspends the print job, and the processing proceeds to step S1915.

In step S1915, the device control unit 901 sends a stack eject request to the high-capacity stacker 204, and the processing proceeds to step S1916.

In step S1916, the device control unit 901 resumes the suspended job and prints an image on a sheet on the basis of the RIP image of the subsequent page. More specifically, in the above-described example, images are printed on sheets on the basis of the RIP images of a first page of copy 501 and the subsequent pages. Thereafter, the processing is completed.

Note that the processes performed in step S1903 and steps S1906 to S1912 are similar to the processes performed in step S1403 and steps S1404 to S1410 of the first exemplary embodiment, respectively. Accordingly, descriptions of the processes are not repeated.

As described above, according to the present exemplary embodiment, the operator can select whether a sample print of the same page is produced before and after stack eject.

Note that according to the present exemplary embodiment, like the first exemplary embodiment, the process performed when the operator performs stack eject may be replaced with the process performed when the button 501 of the high-capacity stacker 204 is pressed.

### Fourth Exemplary Embodiment

A fourth exemplary embodiment is described with reference to the case in which a sample print is not produced before stack eject if the stack eject request is received during outputting printed sheets onto the lift table 508 of the high-capacity stacker 204. More specifically, if a top surface of the topmost medium of the printed material output from the high-capacity stacker 204 is printed, a sample print is not produced.

Note that according to the present exemplary embodiment, the print job is sent to the information processing apparatus 102 after the operator sets up the job setting screen using the display unit 802 of the information processing apparatus 103 as illustrated in FIGS. 12A and 12B.

Since the process performed when the operator performs stack eject is similar to that of the first exemplary embodiment, description of the process is not repeated.

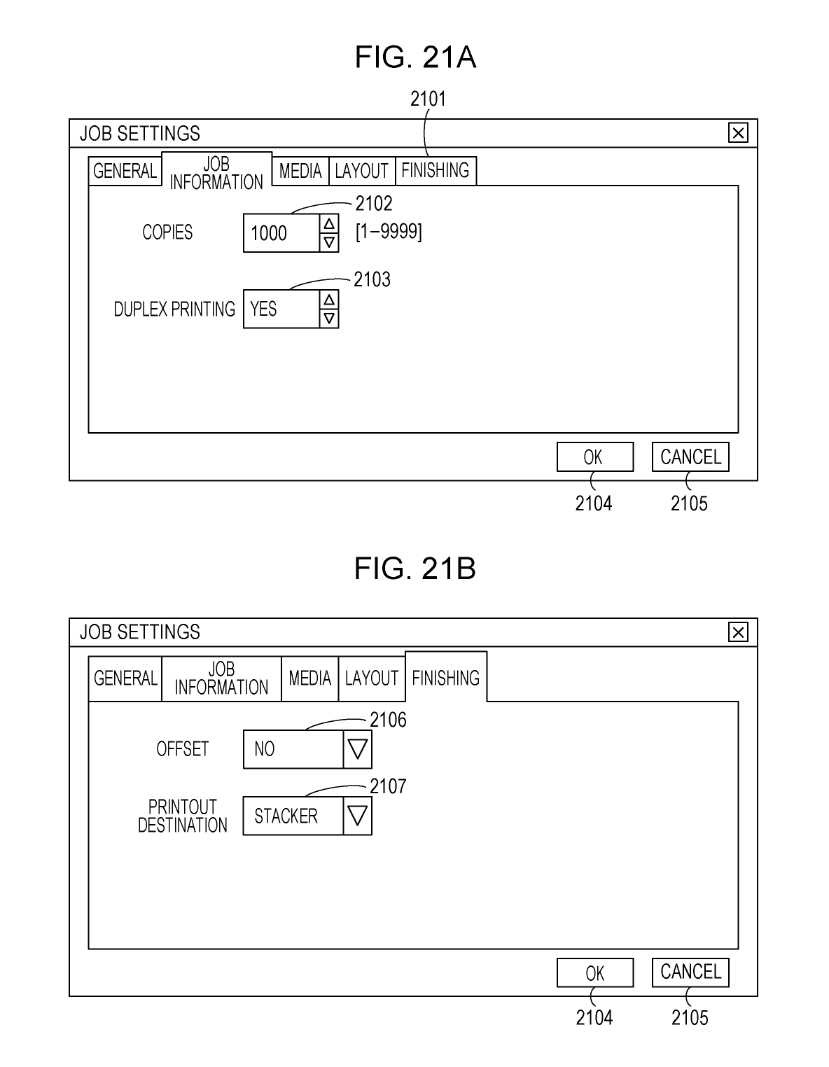

FIG. 20 is a flowchart illustrating a technique for controlling a printing apparatus according to the present exemplary embodiment. In this example, processes are performed by the printing apparatus 101 illustrated in FIG. 1. The steps of the process are realized by the CPU 606 that executes a control program stored in the ROM 607. In addition, the following description is made with reference to the software modules.

Note that since the processes performed in steps S2001 to S2006 are similar to the processes performed in steps S1401 to S1406 of the first exemplary embodiment, respectively, descriptions of the processes are not repeated.

In step S2007, the device control unit 901 determines whether the last page of the copy is printed face up. For example, the device control unit 901 can determine whether the last page of the copy is printed face up on the basis of the duplex printing setting 1203 illustrated in FIG. 12A, the page order setting 1208 illustrated in FIG. 12B, and the number of pages of the print job.

For example, when the print job has 10 pages and if the duplex printing setting 1203 is “yes” and the page order setting 1208 is “face down”, the device control unit 901 can determine that the last page of the copy is printed face up. As another example, when the print job has 9 pages and if the duplex printing setting 1203 is “yes” and the page order setting 1208 is “face down”, the device control unit 901 can determine that the last page of the copy is printed face down. In this manner, if the device control unit 901 determines that the last page of the copy is printed face up, the processing proceeds to step S2009. Otherwise, the processing proceeds to step S2008.

Note that the processes performed in steps S2008 to 52011 are similar to the processes performed in step S1407 to S1410 of the first exemplary embodiment illustrated in FIG. 14, respectively. Accordingly, descriptions of the processes are not repeated.

As described above, according to the present exemplary embodiment, if the top surface of the topmost medium of a printed material removed from the high-capacity stacker 204 is printed, the need for a sample print produced before stack eject can be eliminated.

By comparing the topmost medium of the print stack subjected to stack eject with the sample print output onto the escape tray 506, the operator can examine a tint variation with the naked eye. Accordingly, a print medium is not wasted.

Note that the process according to the present exemplary embodiment can be also applied to the second and third exemplary embodiments.

More specifically, in the second exemplary embodiment, if the top surface of the topmost medium of the printed material removed from the high-capacity stacker 204 is printed, the need for a sample print produced before stack eject can be eliminated. This is accomplished by replacing step S1706 illustrated in FIG. 17 with steps S2007 and S2008 illustrated in FIG. 20.

Furthermore, in the third exemplary embodiment, if the top surface of the topmost medium of the printed material removed from the high-capacity stacker 204 is printed, the need for a sample print produced before stack eject can be eliminated. This is accomplished by replacing step S1909 illustrated in FIG. 19 with steps S2007 and S2008 illustrated in FIG. 20.

Still furthermore, in the fourth exemplary embodiment, if, like the first exemplary embodiment, the process performed when the operator performs stack eject may be replaced with the process performed when the button 501 of the high-capacity stacker 204 is pressed.

### Fifth Exemplary Embodiment

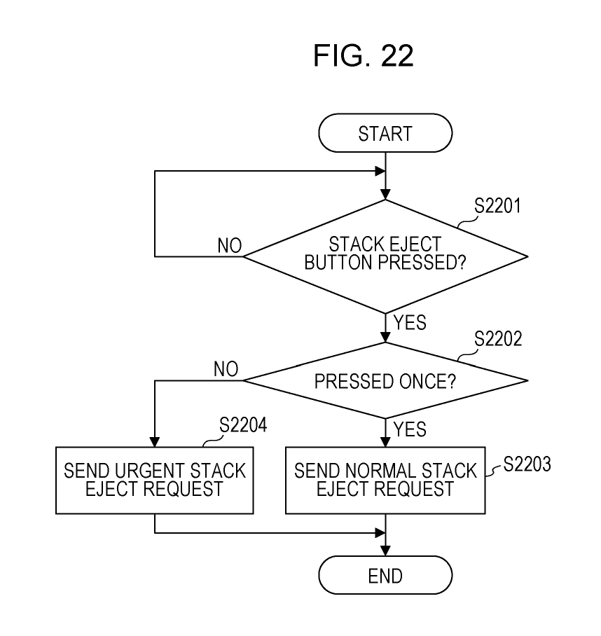

FIGS. 21A and 21B illustrate examples of a UI screen displayed on the display unit 802 of the information processing apparatus 102 illustrated in FIG. 1. This UI screen is an example of the job setting screen.

As illustrated in FIG. 21A, a tab group 2101 includes five job setting items: “General”, “Job Information”, “Media”, “Layout”, and “Finishing”. In FIG. 21A, the setting items of “Job Information” are displayed.

The settings in the tab “Job Information” are applied to all print jobs. The “copies” setting 2102 indicates the number of copies when printing the print data. In FIG. 21A, 1000 copies are printed. The “Duplex Printing” setting 2103 indicates whether the print data is printed in a duplex mode. In FIG. 21A, print data is printed in a duplex mode.

The OK button 2104 is used to accept the settings input in the job setting screen as the settings for the job. The “Cancel” button 2105 is used to cancel the settings input in the job setting screen. Note that if the OK button 2104 or the “Cancel” button 2105 is pressed, the job setting screen is closed.

The setting items in “Finishing” setting tab are displayed in the UI screen illustrated in FIG. 21B.

The “Finishing” tab includes the sheet output settings. “Offset” setting 2106 has a pull down menu used to select whether sheets are offset when the sheets are output. In FIG. 21B, non-offset setting is selected.

A printout destination setting 2107 is used to select the destination of printed media. This setting is made by selecting “Escape Tray” or “Stacker”. In FIG. 21B, “Stacker” is selected. According to the present exemplary embodiment, “Stacker” indicates the lift table 508 of the high-capacity stacker 204.

Since an OK button 2104 and a cancel button 2105 are similar to those in FIG. 21A, descriptions of the buttons are not repeated.

According to the present exemplary embodiment, the case in which a request for removing printed media stacked on the lift table 508 from the high-capacity stacker 204 (hereinafter referred to as a “stack eject request”) is received during outputting the printed media onto the lift table 508 of the high-capacity stacker 204 is discussed below.

According to the present exemplary embodiment, the case in which a sample print is automatically produced when a normal stack eject request is received is described. As used herein, the term “normal stack eject request” refers to a request for stack eject performed at the last page of a copy during the period for which media are output onto the lift table 508 in order for an operator to remove the printed media for post-processing. In addition, the term “urgent stack eject request” refers to a request sent when the operator is aware of a variation of print conditions and wants to urgently remove the printed media currently being stacked on the lift table 508 even when the last page of a copy has not been printed.

According to the present exemplary embodiment, the type of stack eject request is changed depending on the number of presses on the button 501 of the high-capacity stacker 204. More specifically, if the operator presses the button 501 once, a normal stack eject request is sent. In contrast, if the operator presses the button 501 twice, an urgent stack eject request is sent.

Note that according to the present exemplary embodiment, the operator submits a print job to the information processing apparatus 102 after setting up the job setting screen displayed on the display unit 802 of the information processing apparatus 103 in the same manner as illustrated in FIGS. 21A and 21B.

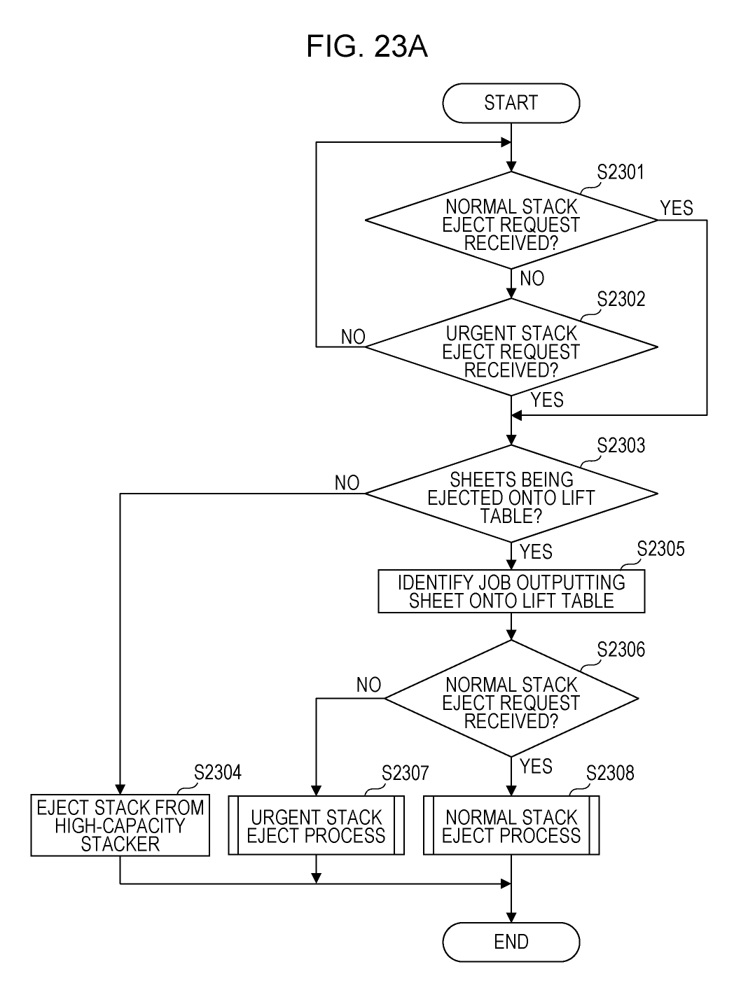

FIG. 22 is a flowchart illustrating a technique for controlling the printing apparatus according to the present exemplary embodiment. In this example, processes are performed by the printing apparatus 101 illustrated in FIG. 1. The steps of the process are realized by the CPU 606 that executes a control program stored in the ROM 607. The following description is made with reference to the software modules.

In step S2201, the stacker control unit 610 determines whether the operator presses the button 501. If the stacker control unit 610 determines that the operator presses the button 501, the button press detection unit 709 of the stacker control unit 610 detects the number of presses on the button 501 and sends information indicating the number of presses on the button 501 to the device control unit 901 operating in the CPU circuit unit 605. Upon detecting that the button 501 is pressed in this manner, the processing performed by the device control unit 901 proceeds to step S2202. However, if any press is not detected, the processing returns to step S2201.

In step S2202, the device control unit 901 determines whether the button 501 is pressed once. If the device control unit 901 determines that the button 501 is pressed once, the processing proceeds to step S2203. However, if the device control unit 901 determines that the button 501 is not pressed once, the processing proceeds to step S2204.

In step S2203, the device control unit 901 submits a normal stack eject request and completes the processing. In step S2204, the device control unit 901 submits an urgent stack eject request and completes the processing.

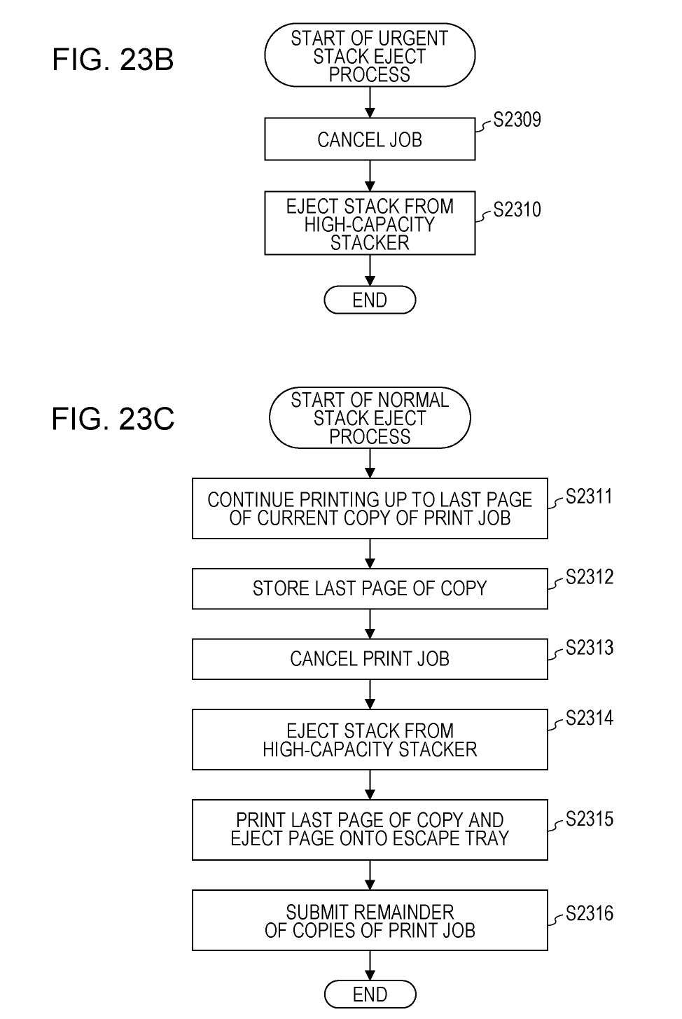

FIG. 23 is a flowchart illustrating a technique for controlling the printing apparatus according to the present exemplary embodiment. In this example, processes are performed by the printing apparatus 101 illustrated in FIG. 1. The steps of the process are realized by the CPU 606 that executes a control program stored in the ROM 607. The following description is made with reference to the software modules.

In step S2301, the device control unit 901 determines whether the type of stack eject request is a normal stack eject request. More specifically, the type can be determined by using the information sent in the process illustrated in FIG. 22.

If the device control unit 901 determines that the type of stack eject request is a normal stack eject request, the processing proceeds to step S2303. However, if the device control unit 901 determines that the type of stack eject request is not a normal stack eject request, the processing proceeds to step S2302. In step S2302, the device control unit 901 determines whether the type of stack eject request is an urgent stack eject request.

If the device control unit 901 determines that the type of stack eject request is not an urgent stack eject request, the processing returns to step S2301.

However, if the device control unit 901 determines that the type of stack eject request is an urgent stack eject request, the processing proceeds to step S2303.

In step S2303, the device control unit 901 determine whether the printed sheets are output onto the lift table 508 by the executed print job. More specifically, if a job currently in a print mode is found, the device control unit 901 can determine whether the sheets are being output onto the lift table 508 by referring to the printout destination setting 1207 for the print job in a print mode.

That is, if a print job currently in a print mode is not found or if the printout destination setting 1207 of the print job currently in a print mode indicates the escape tray, the processing proceeds to step S2304. However, if the printout destination setting 1207 of the print job currently in a print mode indicates a stacker, the processing proceeds to step S2305.

In step S2304, the device control unit 901 issues a stack eject request and completes the processing. Thereafter, the device control unit 901 sends the stack eject request to the high-capacity stacker 204. Upon receiving the stack eject request, the high-capacity stacker 204 moves the slide door 502 upward and moves the printed media stacked on the lift table 508 to the eject table 509 so as to remove the media.

In step S2305, the device control unit 901 identifies the print job currently outputting sheets onto the lift table 508, and the processing proceeds to step S2306.

In step S2306, the device control unit 901 determines whether the stack eject request received in step S2301 or S2302 is a normal stack eject request or an urgent stack eject request. If the device control unit 901 determines that the stack eject request is an urgent stack eject request, the processing proceeds to step S2307. However, if the device control unit 901 determines that the stack eject request is a normal stack eject request, the processing proceeds to step S2308.

FIG. 23B is a detailed flowchart of the urgent stack eject process performed in step S2307.

In step S2309, the device control unit 901 cancels the print job identified in step S2305. Thereafter, the processing proceeds to step S2310. In this manner, printing is stopped.

In step S2310, the device control unit 901 sends a stack eject request to the high-capacity stacker 204 and completes the processing. Note that since the operation performed after the stack eject request is sent has already been described in step S2304, description of the operation is not repeated.

FIG. 23C is a detailed flowchart of the normal stack eject process performed in step S2308.

In step S2311, the device control unit 901 performs printing for the identified print job up to the last page of the currently printed copy. For example, if the print job has image data for 10 pages and plans to print 1000 copies, the device control unit 901 prints images on sheets on the basis of the RIP images for up to page 10 of copy 500.

In step S2312, the device control unit 901 stores the RIP image for the last page of the identified print job in the HDD 613. Thereafter, the processing proceeds to step S2313.

In step S2313, the device control unit 901 cancels the print job identified in step S2305. Thereafter, the processing proceeds to step S2314.

In step S2314, the device control unit 901 sends a stack eject request to the high-capacity stacker 204. Thereafter, the processing proceeds to step S2315. Note that since the operation performed after the stack eject request is sent has already been described in step S2304, description of the operation is not repeated.

In step S2315, the device control unit 901 prints an image on a sheet on the basis of the RIP image of the last page of the stored print job and outputs the sheet onto the escape tray 506. Thereafter, the processing proceeds to step S2316.

In step S2316, the device control unit 901 resumes the job to print the remainder of the pages. In the above-described example, the print job is submitted again to print from page 1 of copy 501 to page 10 of copy 1000. After this process is completed, the processing is completed.

As described above, according to the present exemplary embodiment, a sample print is automatically produced only when a normal stack eject request is received. Accordingly, to examine the tint, a sample print is produced for only a print media for which the operator wants to perform post-processing (e.g., finishing).

In addition, since a sample print is automatically produced by simply pressing the button 501 of the high-capacity stacker 204, the need for a troublesome manual operation performed by the operator can be eliminated.

According to the present exemplary embodiment, the process performed after a normal stack eject request or an urgent stack eject request is received is realized by canceling the print job. Accordingly, such a process can be advantageously performed by using an image forming apparatus having only a job print function and job cancel function.

### Sixth Exemplary Embodiment

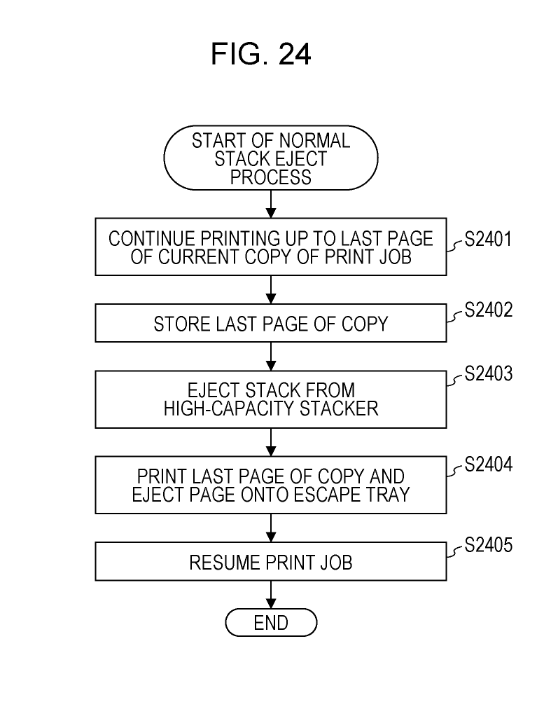

According to the present exemplary embodiment, the normal stack eject process of the fifth exemplary embodiment is realized by suspending a print job. The present exemplary embodiment is described below with reference to FIG. 22, FIGS. 23A and 23B, and FIG. 24. Since FIG. 22 and FIGS. 23A and 23B have been described in the fifth exemplary embodiment, description is made with reference to only FIG. 24.

FIG. 24 is a flowchart illustrating a technique for controlling the printing apparatus according to the present exemplary embodiment. In this example, processes are performed by the printing apparatus 101 illustrated in FIG. 1. The steps of the process are realized by the CPU 606 that executes a control program stored in the HDD 613. Note that a process illustrated in FIG. 24 according to the present exemplary embodiment is performed when step S2308 of FIG. 23A starts.

In step S2401, the device control unit 901 performs printing for the identified print job up to the last page of the currently printed copy. For example, let the print job have image data for 10 pages and plan to print 1000 copies. Then, the device control unit 901 prints images on sheets on the basis of the RIP images for up to page 10 of copy 500. Thereafter, the device control unit 901 sets the identified print job in a suspended mode. Thereafter, the processing proceeds to step S2402.

In step S2402, the device control unit 901 instructs the RIP processing unit 907 to store the RIP image of the last page of the identified print job in the HDD 613. Thereafter, the processing proceeds to step S2403, where the device control unit 901 submits a stack eject request. Thereafter, the processing proceeds to step S2404. Note that since the operation performed after the stack eject request is sent has already been described in the first exemplary embodiment, description of the operation is not repeated.

In step S2404, the device control unit 901 prints an image on a sheet on the basis of the RIP image of the last page of the stored print job and outputs the sheet onto the escape tray 506. Thereafter, the processing proceeds to step S2405.

In step S2405, the device control unit 901 resumes the job suspended in step S2401 so as to print images on sheets on the basis of the RIP images of the remainder of the pages. In the above-described example, the printing apparatus 101 prints images based on the RIP images of page 1 of copy 501 and the subsequent pages. Thereafter, the processing is completed.

According to the present exemplary embodiment, unlike the fifth exemplary embodiment, the process is performed using the suspended mode of the job. Accordingly, the processing time required for resuming the print job can be decreased from that when canceling the print job.

### Seventh Exemplary Embodiment

According to the present exemplary embodiment, in the urgent stack eject process of the fifth exemplary embodiment, one of suspension of the print job and cancellation of the print job is made selectable.

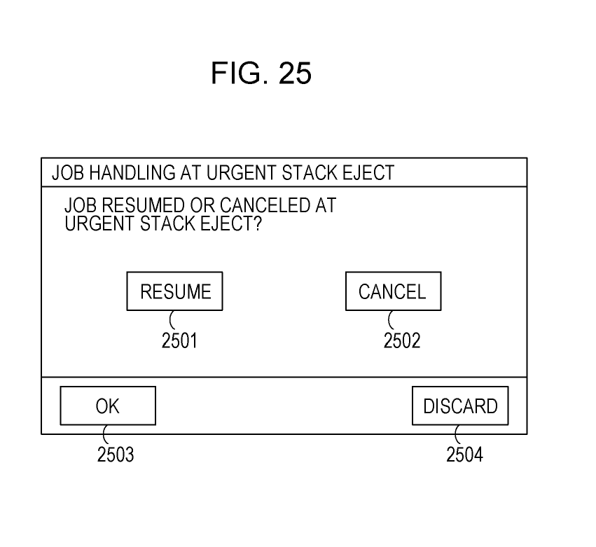

FIG. 25 illustrates an example of a UI screen displayed on the display unit 802 of the information processing apparatus 102 illustrated in FIG. 1. The example of a UI screen is a job handling screen for urgent stack eject.

In FIG. 25, a suspend button 2501 is used to perform settings so that a selected job is suspended in the case of reception of an urgent stack eject request. In addition, a cancel button 2502 is used to perform settings so that the selected job is canceled in the case of reception of an urgent stack eject request. The suspend button 2501 and the cancel button 2502 are radio buttons and, thus, two buttons cannot be selected at the same time.

An OK button 2503 is used to confirm the selected one of the suspend button 2501 and the cancel button 2502. If the OK button 2503 is pressed, the UI processing unit 905 stores, in the HDD 809 of the information processing apparatus 102, information as to which one of the buttons is selected. A discard button 2504 is used to discard the selection of one of the suspend button 2501 and the cancel button 2502 and, thus, the information is not stored in the HDD 809 of the information processing apparatus 102.

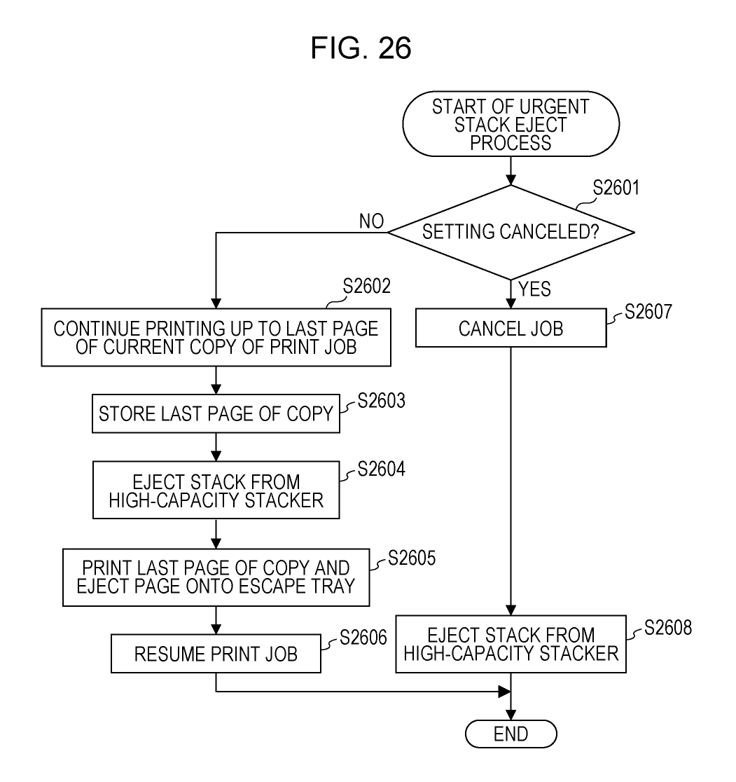

According to the present exemplary embodiment, a process illustrated in FIG. 26 is performed instead of the process illustrated in FIG. 23B. The process is described below with reference to FIG. 25 and FIGS. 22, 23A, 23C and 26. Note that since FIG. 22 and FIGS. 23A and 23C have already been described in the fifth exemplary embodiment, description is made with reference to only FIGS. 25 and 26.

FIG. 26 is a flowchart illustrating a technique for controlling the printing apparatus according to the present exemplary embodiment. In this example, processes are performed by the printing apparatus 101 illustrated in FIG. 1. The steps of the process are realized by the CPU 606 that executes a control program stored in the HDD 613. Note that a process indicated by a flowchart in FIG. 26 according to the present exemplary embodiment is performed when step S2307 of FIG. 23A starts.

In step S2601, the device control unit 901 reads the value set for the urgent stack eject illustrated in FIG. 25 through the job handling screen and determines a process to be subsequently performed. More specifically, the device control unit 901 reads the value stored in the HDD 613 if the UI processing unit 905 detects that an OK button 1403 is pressed. If the device control unit 901 determines that the stored value indicates suspension, the processing proceeds to step S2602. However, if the device control unit 901 determines that the stored value indicates cancellation, the processing proceeds to step S2607.

The processes performed in steps S2602 to S2606 are similar to the processes performed in steps S2401 to S2405 of the sixth exemplary embodiment, respectively. Accordingly, descriptions of the processes are not repeated. In addition, the processes performed in steps S2607 and S2608 are similar to the processes performed in steps S2309 and S2310 of the fifth exemplary embodiment, respectively. Accordingly, descriptions of the processes are not repeated.

As described above, according to the present exemplary embodiment, the operator can select one of different urgent stack eject processes. More specifically, if the operator suspends a job when an urgent stack eject process is performed, a sample print is automatically produced. In contrast, if the job is canceled when an urgent stack eject process is performed, a sample print is not produced. In this manner, the flexibility of an operation performed by the operator can be increased.

While the above-described exemplary embodiments have been described with reference to the information processing apparatus 102 and the printing apparatus 101 separated from each other, the information processing apparatus 102 and the printing apparatus 101 may be integrated with each other. In such a case, the above-described UI screens are displayed on a display unit of the operation unit of the printing apparatus 101. Alternatively, the information processing apparatus 103, the information processing apparatus 102, and the printing apparatus 101 may be integrated into one body.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-099918 filed May 10, 2013, which is hereby incorporated by reference herein in its entirety.

What is claimed is:

1. A printing apparatus comprising:
a printing unit configured to print an image on a sheet;
a discharging unit configured to discharge the sheet having the image printed thereon by the printing unit onto a first stacking unit;
an interrupting unit configured to, upon receiving an instruction from a user, interrupt a print operation performed by the printing unit; and
a control unit configured to, upon receiving an instruction from the user, perform control so that a sheet having a predetermined image printed thereon by the printing unit is discharged onto a second stacking unit before the print operation performed by the printing unit is interrupted, and a sheet having the predetermined image printed thereon by the printing unit is discharged onto the second stacking unit after the print operation performed by the printing unit is started.

2. The printing apparatus according to claim 1, wherein
the instruction from the user is an instruction to remove the sheets stacked on the stacking unit.

3. The printing apparatus according to claim 1, wherein
the predetermined image printed by the printing unit before the print operation performed by the printing unit is interrupted by the interrupting unit is an image printed on the last page before the print operation performed by the printing unit is interrupted by the interrupting unit.

4. The printing apparatus according to claim 2, wherein
the predetermined image printed by the printing unit after the print operation performed by the printing unit starts is an image printed on the last page before the print operation performed by the printing unit is interrupted by the interrupting unit.

5. The printing apparatus according to claim 1, further comprising:
a setting unit configured to perform setting as to whether the predetermined image is to be printed by the printing unit,
wherein if setting is performed by the setting unit so that the predetermined image is to be printed by the printing unit, the control unit performs control upon receiving an instruction from the user so that the sheet having the predetermined image printed thereon by the printing unit is discharged onto the second stacking unit before the print operation performed by the printing unit is interrupted by the interrupting unit, and a sheet having the predetermined image printed thereon by the printing unit is discharged to the second stacking unit after the print operation performed by the printing unit starts.

6. The printing apparatus according to claim 1, further comprising:
a determining unit configured to determine whether the last page printed before the print operation performed by the printing unit is interrupted is discharged face up,
wherein upon receiving an instruction from the user, the control unit does not print the predetermined image using the printing unit.

7. A control method for controlling a printing apparatus comprising:
printing an image on a sheet;
discharging the sheet having the image printed thereon by the printing unit onto a first stacking unit;
upon receiving an instruction from a user, interrupting a print operation performed by the printing unit; and
upon receiving an instruction from the user, performing control so that a sheet having a predetermined image printed thereon by the printing unit is discharged onto a second stacking unit before the print operation performed by the printing unit is interrupted, and a sheet having the predetermined image printed thereon by the printing unit is discharged onto the second stacking unit after the print operation performed by the printing unit is started.

8. A non-transitory computer readable storage medium for storing a computer program for controlling a printing apparatus, the computer program comprising:
a code to print an image on a sheet;
a code to discharge the sheet having the image printed thereon by the printing unit onto a first stacking unit;
a code to, upon receiving an instruction from a user, interrupt a print operation performed by the printing unit; and
a code to, upon receiving an instruction from the user, perform control so that a sheet having a predetermined image printed thereon by the printing unit is discharged onto a second stacking unit before the print operation performed by the printing unit is interrupted, and a sheet having the predetermined image printed thereon by the printing unit is discharged onto the second stacking unit after the print operation performed by the printing unit is started.
